(19) United States
(12) Patent Application Publication
(10) Pub. No.: US 2025/0368917 A1
(43) Pub. Date: Dec. 4, 2025

(54) SYSTEMS AND METHODS FOR REDUCING RENDERED FATS POUR POINT

(71) Applicant: Marathon Petroleum Company LP, Findlay, OH (US)

(72) Inventors: Daniel Z. Short, Findlay, OH (US); Nathan R. Klaus, Findlay, OH (US); David G. Teschel, Findlay, OH (US); Paul J. Dofton, Findlay, OH (US); Justin L. Womeldorff, Findlay, OH (US); Michelle Smith, Findlay, OH (US); Peg Broughton, Findlay, OH (US); Caleb S. Litchfield, Findlay, OH (US)

(73) Assignee: Marathon Petroleum Company LP, Findlay, OH (US)

(21) Appl. No.: 19/205,226

(22) Filed: May 12, 2025

Related U.S. Application Data
(63) Continuation of application No. 18/243,206, filed on Sep. 7, 2023, now Pat. No. 12,297,403.
Application No. 18/243,206 is a continuation of application No. 18/103,633, filed on Jan. 31, 2023, now Pat. No. 11,802,257.
(60) Provisional application No. 63/267,317, filed on Jan. 31, 2022.

(51) Int. Cl. C11B 3/00; C10L 1/02

(52) U.S. Cl. CPC C11B 3/00; C10L 1/026; C10L 2200/0484; C10L 2230/14; C10L 2270/026; C10L 2290/24; C10L 2290/58

(57) ABSTRACT

Systems and methods to reduce pour point (PP) temperatures of fat-based compositions for use in transportation fuels. In one or more embodiments, methods and systems reduce the pour point of rendered fats using biologically-derived plant oils for effectively transporting the blended fat based compositions over long distances, thereby advantageously decreasing the heating and mixing requirements needed to maintain the compositional temperature above the pour point. In certain embodiments, the fat based composition comprises rendered animal fats, such as tallow in combination with distilled corn oil (DCO).

### CROSS-REFERENCE TO RELATED APPLICATIONS

The present application is a continuation of U.S. patent application Ser. No. 18/243,206, filed Sep. 7, 2023, which is a continuation of U.S. patent application Ser. No. 18/103,633, filed Jan. 31, 2023, now U.S. Pat. No. 11,802,257, which claims priority to and the benefit of U.S. Provisional Application No. 63/267,317, filed Jan. 31, 2022, titled “SYSTEMS AND METHODS FOR REDUCING RENDERED FATS POUR POINT AND TRANSPORTING BLENDED FAT BASED COMPOSITIONS,” the disclosure of which is incorporated herein by reference in its entirety.

### FIELD OF DISCLOSURE

The present disclosure relates to fuel processing facility methods and systems for blending rendered fats, including beef and/or mutton fat commonly referred to as tallow, as well as additional fats/oils derived from bovine, ovine, piscine, porcine, and poultry and, in some embodiments used cooking oil and/or other biological-based oil exhibiting similar properties, with biological-based oils and related compositions derived from plant and legume sources, that are capable of being used in the production of transportation fuel. More specifically, the present disclosure relates to methods and systems for reducing the pour point of rendered fats to transport long distances.

### BACKGROUND

Increasingly, there is a demand for renewable feedstock to produce renewable fuels that are environmentally friendly. Renewable feedstock including biological-based oils (such as raw, degummed and/or refined varieties of soybean oil, corn oil, sorghum oil, canola oil, rapeseed oil, algal oil, fish oil, chufa/tigernut oil, sativa seed oil, coconut oil, related oils and blends thereof), rendered fats, and other miscellaneous renewable feedstock are processed into renewable diesel, naphtha, propane and treated fuel gas, for example.

Accordingly, in the production of transportation fuels, such as renewable diesel fuel, it is common to transport rendered fats long distances to different processing facilities. Rendered fats typically have a melting point of about 130 degrees Fahrenheit (° F.) to about 140° F.

### SUMMARY OF THE DISCLOSURE

Applicants have recognized that this high melting temperature generally requires additional handling requirements during transport and upon reaching processing destinations, such as heating and mixing in order to efficiently offload the rendered fats, which creates additional expense in the fuel production process. In addition, if the rendered fats are cooled lower than the pour point during transport, even more expenses are incurred during the fuel production process.

Applicants recognized the problems noted above herein, and the present disclosure is direct to embodiments of methods and systems of reducing the pour point of the rendered fats, thereby decreasing heating and mixing requirements needed to maintain the rendered fats temperature above the pour point, for example.

The present disclosure includes embodiments of methods of reducing the pour point for fat based compositions and related compositions comprising greases, oils and blends thereof for transport from a first location to a second location to process into a transportation fuel, for example. In non-limiting embodiments, the compositions may comprise or consist of one or more rendered fats, including tallow, choice white grease (CWG), additional fats/oils derived from bovine, ovine, piscine, porcine and poultry, and, in some embodiments used cooking oil (UCO) and/or other biological-based oil exhibiting similar properties that are capable of being blended with biological-based oil and/or related compositions derived from plant and legume sources including technical corn oil (TCO), distillers corn oil (DCO), soybean oil, sorghum oil, canola oil, rapeseed oil, algal oil, fish oil, chufa/tigernut oil, sativa seed oil, coconut oil, and combinations thereof. In an embodiment, a selected quantity of rendered fats and a selected quantity of biological-based oil, such as distillers corn oil (DCO), may be supplied to a first tank positioned at a first location. The rendered fats may be supplied at a first selected temperature equal to or greater than a pour point of the rendered fats, and the DCO may be supplied at a second selected temperature lower than the first selected temperature and equal to or greater than a pour point of the DCO. The selected quantity of rendered fats and the selected quantity of DCO may be mixed in the first tank to form a blended fat composition having a third selected temperature. The third selected temperature may be less than the first selected temperature but greater than the second selected temperature and may be a high enough temperature equal to or greater than a pour point of the blended fat composition. Further, the third selected temperature of the blended fat composition may be maintained in the first tank so that the blended fat composition remains at a temperature above a reduced pour point less than the pour point of the rendered fats being supplied to the first tank, which defines a blended fat composition having the reduced pour point.

In embodiments, the blended fat composition, in turn, may be supplied to one or more transport vehicles, and each of the one or more transport vehicles, e.g., a railcar, may be configured to substantially maintain the blended fat composition at a temperature above the reduced pour point or reduced pour point temperature. For example, as will be understood by those skilled in the art, a railcar, for example, may be equipped with a heating element and/or insulation. The blended fat composition may be transported to the second location remote from the first location while the blended fat composition substantially maintains the reduced pour point. The blended fat composition from the one or more transport vehicles at the reduced pour point may be supplied to a second tank at the second location to further process into a transportation fuel, as will be understood by those skilled in the art.

Another embodiment of the disclosure is directed to a method of reducing pour point for a blended fat composition. The method may include supplying (a) a selected quantity of rendered fats at a first selected temperature equal to or greater than a pour point of the rendered fats and (b) a selected quantity of a biological-based oil at a second selected temperature lower than the first selected temperature and equal to or greater than a pour point of the biological-based oil. The method may include mixing the selected quantity of rendered fats and the selected quantity of the biological-based oil in via a mixing device, thereby to form a blended fat composition with a reduced pour point less than the pour point of the rendered fats. The method may include maintaining a third selected temperature of the blended fat composition in the mixing device. The method may include supplying the blended fat composition for further use at a fuel processing facility while the third selected temperature is maintained.

In another embodiment, the mixing device may comprise one or more of a mixing tank, in-line mixing pipeline, or mixing element in a transport vehicle. In another embodiment, further use of the blended fat composition at the fuel processing facility may comprise processing the blended fat composition into one or more of renewable diesel, naphtha, propane, or treated fuel gas

Another embodiment of the disclosure is directed to a method of reducing pour point for a fat composition to transport the fat composition from a first location to a second location to process into a transportation fuel. The method may include supplying a selected quantity of rendered fats and a selected quantity of a biological-based oil to a first tank positioned at the first location. The rendered fats may be supplied at a first selected temperature equal to or greater than a pour point of the rendered fats and the biological-based oil may be supplied at a second selected temperature lower than the first selected temperature and equal to or greater than a pour point of the biological-based oil. The method may include mixing the selected quantity of rendered fats and the selected quantity of the biological-based oil in the first tank to form a blended fat composition. The method may include maintaining a third selected temperature of the blended fat composition in the first tank so that the blended fat composition has a reduced pour point less than the pour point of the rendered fats being supplied to the first tank. The method may include supplying the blended fat composition to one or more transport vehicles, the one or more transport vehicles each configured to (a) transport the blended fat composition from the first location to the second location for further processing and (b) maintain the blended fat composition at a temperature above the reduced pour point or reduced pour point temperature during transportation.

In another embodiment, the third selected temperature may be based on one or more of ambient temperature, the pour point of the rendered fats, the pour point of the biological-based oil, or a pour point of the blended fat composition. The method may also include, in response to a change in ambient temperature, adjusting the third selected temperature. The method may include sampling the blended fat composition after mixing in the first tank to measure the pour point of the blended fat composition in accordance with American Society for Testing and Materials (ASTM) D5950 and/or other standards. Further, the third selected temperature may be based on a measured pour point of the blended fat composition in the first tank.

In another embodiment, the first location may comprise one or more of a fuel processing facility, farm, rendered fat source, or biological-based oil source, and the second location may comprise one or more of a fuel processing facility or a renewable transportation fuel processing location. Further processing of the blended fat composition at a fuel processing facility may include processing the blended fat composition into one or more of renewable diesel, naphtha, propane, treated fuel gas, jet renewable fuel, sustainable aviation kerosene, hydro processed esters.

Accordingly, an embodiment of the disclosure is directed to a system for reducing the pour point for blended fat composition to transport the blended fat composition from a first location to a second location to process into a transportation fuel. A first source of rendered fats may be supplied to a first tank in a selected quantity at a first selected temperature equal to or greater than a pour point of the rendered fats. The biological-based oil may include distillers corn oil (DCO), technical corn oil (TCO), soybean oil, sorghum oil, canola oil, rapeseed oil, algal oil, fish oil, chufa/tigernut oil, sativa seed oil, coconut oil and combinations thereof, may be supplied in a select quantity at a second selected temperature lower than the first selected temperature and equal to or greater than a pour point of the DCO to the first tank. In the system, the first tank may be positioned to receive the first source of rendered fats and the source of DCO at the first location. The first tank may include a mixing element and a heating element to provide the blend fat composition at the third selected temperature that has a reduced pour point less than the pour point of the rendered fats being supplied to the first tank.

In an embodiment of the system, a rendered fats pump positioned between the first source of rendered fats and the first tank may be configured to supply rendered fats to the first tank. The system may include a rendered fats flow control valve connected to and in fluid communication with the first source of rendered fats and connected to and in fluid communication with the first tank. The rendered fats flow control valve may be configured to supply the selected quantity of rendered fats to the first tank to create the blended fat composition. The system may include a rendered fats flow meter being positioned between the rendered fats pump and the first tank to measure an amount of rendered fats supplied to the first tank to create the blended fat composition. The system may further include a biological-based oil pump being positioned between the source of biological-based oil and the first tank. The biological-based oil pump may be configured to supply biological-based oil to the first tank.

The system may include a flow control valve, such as a biological-based oil flow control valve, connected to and in fluid communication with the source of biological-based oil and connected to and in fluid communication with the first tank. The biological-based oil flow control valve may be configured to supply the selected a quantity of biological-based oil to the first tank to create the blended fat composition. Also, the system may include a biological-based oil meter disposed at a position between the biological-based oil pump and the first tank to measure an amount of biological-based oil supplied to the first tank to create the blended fat.

One or more transport vehicles may be positioned to transport the blended fat composition from the first location to a second location remote from the first location, and each of the one or more transport vehicles may be configured to substantially maintain the blended fat composition at a temperature above the reduced pour point or reduced pour point temperature. The system may further include a first tank pump positioned between the first tank and the one or more transport vehicles. The first tank pump may be configured to supply the blended fat composition to the one or more transport vehicles.

The system may further include a first tank flow control valve connected to and in fluid communication with the first tank and connected to and in fluid communication with the one or more transport vehicles. The first tank flow control valve may be configured to supply the blended fat composition to the one or more transport vehicles to transport to a second location. A first tank meter may be disposed at a position between the first tank and the one or more transport vehicles to measure an amount of blended fat composition supplied to the one or more transport vehicles to transport to a second location. A second tank also may be positioned to receive the blended fat composition blend from the one or more transport vehicles. The second tank likewise may include a mixing element and a heating element to maintain the blended fat composition at a temperature above the reduced pour point or reduced pour point temperature.

Another embodiment of the disclosure, for example, is directed to a controller to control a system to reduce pour point for rendered fats to transport blended fat composition from a first location to a second location to process into a transportation fuel. The controller may include a first input/output in signal communication with a rendered fats flow control valves. The rendered fats flow control valves may be connected to and in fluid communication with the first source of rendered fats and may be connected to and in fluid communication with a first tank. The rendered fats flow control valve may be configured to supply a selected quantity of rendered fats to the first tank thereby creating the blended fat composition. The controller may be configured, in relation to the rendered fats flow control valve, to adjust the flowrate of the selected quantity of rendered fats to supply to the first tank.

An embodiment of the controller also may include a second input/output in signal communication with a biological-based oil flow control valves. The biological-based oil flow control valve connected to and in fluid communication with the source of biological-based oil and may be connected to and in fluid communication with a first tank. The biological-based oil flow control valve may be configured to supply a selected a quantity of biological-based oil to the first tank thereby creating the blended fat composition. The controller may be configured, in relation to the biological-based oil flow control valve, to adjust a flowrate of the selected quantity of biological-based oil to supply to the first tank. The controller may further include a third input/output in signal communication with a first tank flow control valve. The first tank flow control valve may be connected to and in fluid communication with the first tank and may be connected to and in fluid communication with one or more transport vehicles. The first tank flow control valve may be configured to supply a quantity of blended fat composition to the one or more transport vehicles to transport to a second location. The controller may be configured, in relation to the biological-based oil flow control valve, to adjust the flowrate of the quantity of blended fat composition to supply to the one or more transport vehicles.

The controller may include a fourth input/output in signal communication with a rendered fats pump positioned between the first source of rendered fats and the first tank. The rendered fats pump may be configured to supply rendered fats to the first tank. The controller may be configured, in relation to the rendered fats pump, to adjust the speed of the rendered fats pump, thereby modifying the flowrate of the selected quantity of rendered fats supplied to the first tank. The controller also may include a fifth input/output in signal communication with a biological-based oil pump positioned between the source of biological-based oil and the first tank. The biological-based oil pump may be configured to supply biological-based oil to the first tank. The controller, in relation to the biological-based oil pump, may be configured to adjust the speed of the biological-based oil pump, thereby modifying the flowrate of the selected quantity of biological-based oil supplied to the first tank. The controller may further include a sixth input/output in signal communication with a first tank pump positioned between the first tank and the one or more transport vehicles. The first tank pump may be configured to supply the blended fat composition to the one or more transport vehicles. The controller may be configured, in relation to the first tank pump, to adjust the speed of the first tank pump, thereby modifying the flowrate of a quantity of blended fat composition supplied to the first tank.

The controller also may include a seventh input/output in signal communication with a mixing element positioned at the first tank to mix the selected quantity of rendered fats and the selected quantity of biological-based oil at the first tank. The controller may be configured, in relation to the mixing element, to control operability of the mixing element at the first tank. The controller may further include an eighth input/output in signal communication with a heating element positioned at the first tank to maintain a third selected temperature. The controller may be configured, in relation to the heating element, to adjust the first tank temperature to maintain the third selected temperature of the blended fat composition at the reduced pour point.

The controller also may include a ninth input/output in signal communication with a rendered fats flow meter disposed at a position between the rendered fats pump and the first tank to measure an amount of rendered fats supplied to the first tank to create the blended fat composition. The controller may be configured, in relation to the rendered fats flow meter, to obtain the flowrate of the rendered fats to the first tank. The controller may include a tenth input/output in signal communication with a biological-based oil flow meter disposed at a position between the biological-based oil pump and the first tank to measure an amount of biological-based oil supplied to the first tank to create the blended fat composition. The controller may be configured, in relation to the biological-based oil low meter, to obtain the flowrate of the biological-based oil to the first tank. The controller may further include an eleventh input/output in signal communication with a first tank flow meter disposed at a position between the first tank and the one or more transport vehicles to measure an amount of blended fat composition supplied to the one or more transport vehicles to transport to a second location. The controller may be configured, in relation to the first tank flow meter, to obtain the flowrate of the blended fat composition from the first tank.

### BRIEF DESCRIPTION OF DRAWINGS

These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting of the disclosure's scope.

FIG. 1 is a simplified flow diagram illustrating a method for reducing pour point for blend fat composition to transport the blended fat composition from a first location to a second location, according to an embodiment of the disclosure.

FIG. 2A is a schematic diagram illustration of a system for reducing the pour point of rendered fats using a first tank and transporting the resulting fat composition from a first location to a second location using a transport vehicle, according to an embodiment of the disclosure.

FIG. 2B is a schematic diagram illustration of a system for reducing the pour point of rendered fats and transporting the resulting fat composition from a first location to a second location using a transport vehicle, according to an embodiment of the disclosure.

FIG. 2C is a schematic diagram illustration of a system for reducing the pour point of rendered fats using a first tank and transporting the resulting fat composition from a first location to a second location using a pipeline, according to an embodiment of the disclosure.

FIG. 2D is a schematic diagram illustration of a system for reducing the pour point of rendered fats and transporting the renders fats and biological-based oil from a first location to a second location using a pipeline, according to an embodiment of the disclosure.

FIG. 2E is a schematic diagram illustration of a system for reducing the pour point of rendered fats, according to an embodiment of the disclosure.

FIG. 3 is a flow diagram that illustrates the production of resulting blended fat composition with a reduced pour point transported from a first location to a second location, according to an embodiment of the disclosure.

FIG. 4 is a simplified flow diagram, implemented in a controller, for managing the reduction of the pour point of render fats and transporting the fat from a first location to a second location, according to an embodiment of the disclosure.

FIG. 5 is a schematic diagram illustration of a system for reducing the pour point of rendered fats and transporting the resulting fat composition from a first location to a second location, according to an embodiment of the disclosure.

FIG. 6 is a schematic diagram illustration of a freight car to a second location and transporting the blended fat composition, according to an embodiment of the disclosure.

FIG. 7 is a schematic diagram illustration of a rail car to a second location and transporting the blended fat composition, according to an embodiment of the disclosure.

FIG. 8 is a schematic diagram illustration of a marine vessel to a second location and transporting the blended fat composition, according to an embodiment of the disclosure.

FIG. 9 is a graph showing the viscosity measured at different temperatures of blended fat compositions, according to an embodiment of the disclosure.

FIG. 10 is a graph showing the viscosity measured at different temperatures of DCO, according to an embodiment of the disclosure.

FIG. 11 is a graph showing the viscosity measured at different temperatures of blended fat compositions at 100 degrees Fahrenheit (100° F.) for various ratios of blended fat compositions, according to an embodiment of the disclosure.

FIG. 12 is a graph showing the viscosity measured at different temperatures of blended fat compositions at 125 degrees Fahrenheit (125° F.) for various ratios of blended fat compositions, according to an embodiment of the disclosure.

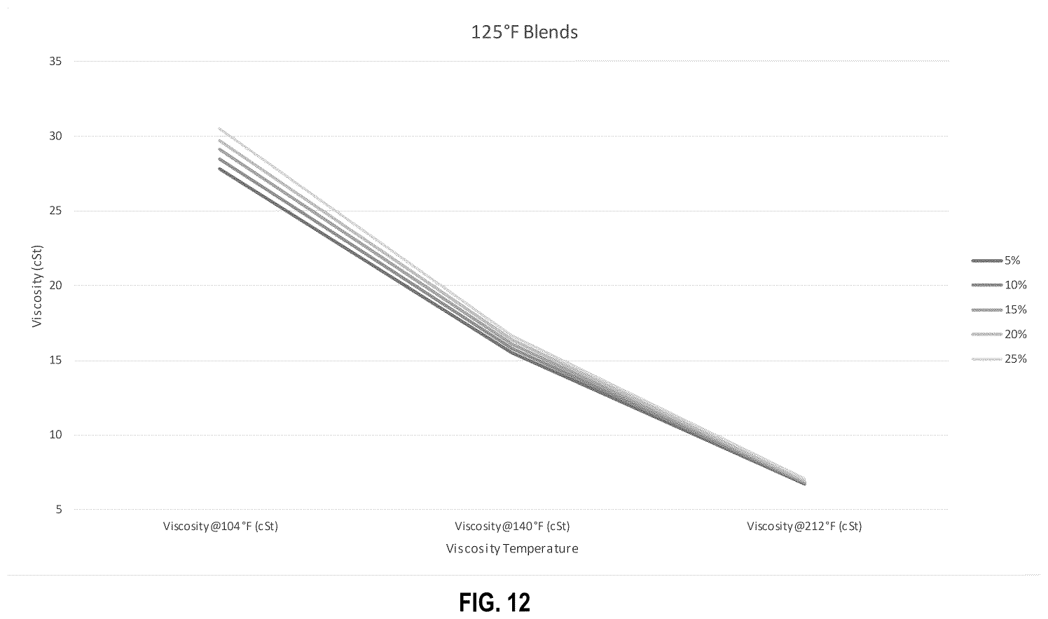

FIG. 13 is a graph showing the pour point of blended fat compositions at 100 degree Fahrenheit (100° F.) for various ratios of blended fat compositions, according to an embodiment of the disclosure.

FIG. 14 is a graph showing the pour point of blended fat compositions at 125 degree Fahrenheit (125° F.) for various ratios of blended fat compositions, according to an embodiment of the disclosure.

FIG. 15 is a graph showing the pour points of blended fat compositions over a temperature range of about-10° C. (about 14° F.) to about 30° C. (about 86° F.) for various ratios of blended fat compositions, according to an embodiment of the disclosure.

### DETAILED DESCRIPTION

So that the manner in which the features and advantages of the embodiments of the systems and methods disclosed herein, as well as others, which will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the systems and methods disclosed herein and are therefore not to be considered limiting of the scope of the systems and methods disclosed herein as it may include other effective embodiments as well.

The term “about” refers to a range of values including the specified value, which a person of ordinary skill in the art would consider reasonably similar to the specified value. In embodiments, “about” refers to values within a standard deviation using measurements generally acceptable in the art. In one non-limiting embodiment, when the term “about” is used with a particular value, then “about” refers to a range extending to ±10% of the specified value, alternatively ±5% of the specified value, or alternatively ±1% of the specified value, or alternatively ±0.5% of the specified value. In embodiments, “about” refers to the specified value.

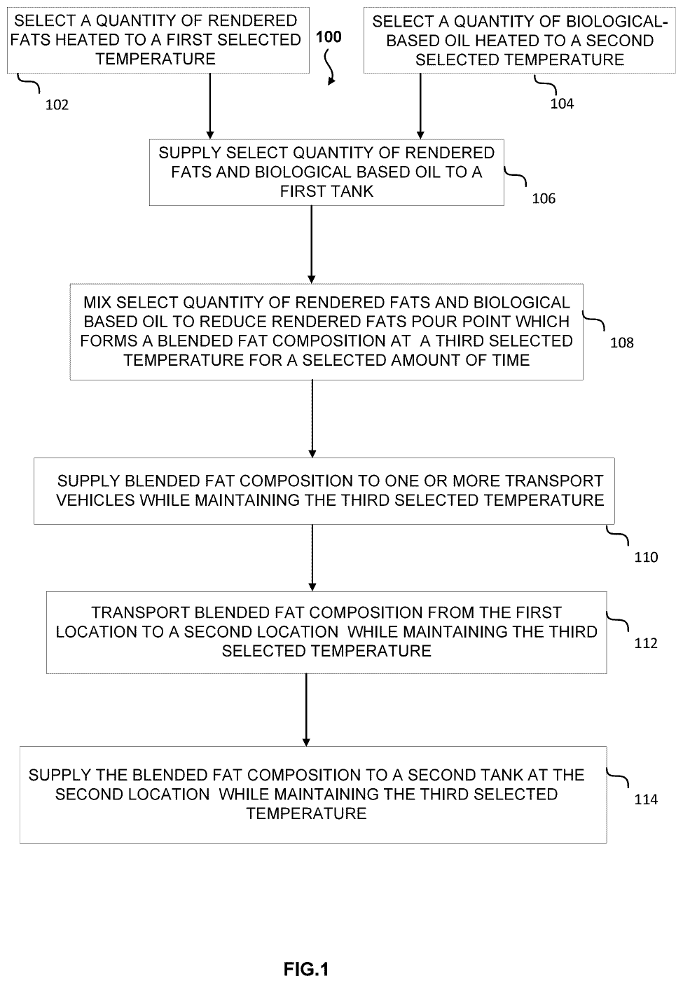

In one or more embodiments, as illustrated in FIGS. 1-8, for example, the present disclosure is directed to systems and methods for blending rendered fats with biological-based oil used in the production of transportation fuel and for reducing the pour point of rendered fat(s) enabling transport of the resulting blended fat composition long distances, such as, a distance of about 50 miles or more, and, for example, to a distant transportation fuel processing plant without the rendered fat solidifying or crashing out of the blended fat composition. In one or more embodiments, the distance or the selected distance (for example, a known distance between a first location and another location remote from the first location) may be from about 5 to about 15 miles, about 15 to about 30 miles, about 30 to about 50 miles, even greater than 50 miles, or even less than 5 miles. In another embodiment, the blended fat composition may be transported intra-facility (for example, from one location in a transportation fuel processing plan to another location within the transportation fuel processing plant).

In one or more embodiments, the present disclosure is directed to a method of reducing pour point for fat (such as rendered fats) to transport a fat based composition from a first location to a second location to process into a transportation fuel. FIG. 1 is a simplified block diagram for reducing the pour point for fat. The fat or rendered fat may include tallow, choice white grease (CWG), and/or additional fats/oils derived from bovine, ovine, piscine, porcine and poultry and, in some embodiments used cooking oil (UCO) and/or other biological-based oil exhibiting similar properties as will be understood by those skilled in the art. The fat, as noted, may be mixed with a biological-based oil to create a blended fat composition. The biological-based may include one or more of biological-based oil, such as technical corn oil (TCO), distillers corn oil (DCO), soybean oil, sorghum oil, canola oil, rapeseed oil, algal oil, fish oil, chufa/tigernut oil, sativa seed oil, coconut oil, and combinations thereof. Biological-based oil and biological-derived oil may be used interchangeably. The method begins at step 102 of selecting a quantity of rendered fats is heated to a first selected temperature. The selected quantity of rendered fats may be heated at the source of the rendered fats. The selected quantity of rendered fats may be heated in the system piping using in-line heaters and/or heat tracing in and/or on the piping. The first selected temperature may be equal to or greater than about 90° F. (32.2° C.). The rendered fats may be supplied from animal processing facilities, e.g. slaughterhouses and animal product packaging facilities, commercial restaurants, and/or other sources of fats and/or oils as will be understood by one skilled in the art. The selected quantity of rendered fats may be selected based on instructions from a controller or may be selected by an operator. The selected quantity of rendered fats may be heated to above the pour point of render fats. The selected quantity of rendered fats may be heated at or above 90° F. (32.2° C.). The select quantity of rendered fats may be heated above the melting point of rendered fats, with the melting point of rendered fats in a range from about 90° F. (32.2° C.) to about 140° F. (60° C.), including ranges from about 90° F. (32.2° C.) to about 130° F. (54.4° C.), 90° F. (32.2° C.) to about 120° F. (48.9° C.), or about 110° F. (43.3° C.) to about 120° F. (48.9° C.). In certain embodiments, the rendered fats is heated by a heat exchanger to the first selected temperature.

Step 102 may be performed simultaneously or substantially simultaneously with step 104. At step 104 a selected quantity of biological-based oil is heated to a second selected temperature. In certain embodiments, step 102 and step 104 may be performed sequentially. The selected quantity of biological-based oil may be heated at the source of the rendered fats. The selected quantity of biological-based oil may be heated in the system piping using in-line heaters. The second selected temperature may be ranging from about 90° F. to about 140° F. In certain embodiments, the second selected temperature may range from about 90° F. to about 120° F., from about 90° F. to about 110° F., from about 90° F. to about 100° F., from about 95° F. to about 105° F., or from about 105° F. to about 115° F. Biological-based oil may be supplied from farms and refineries performing portions of ethanol production processes. The selected quantity of biological-based oil may be selected based on instructions from a controller or may be selected by an operator. The selected quantity of biological-based oil may be heated to above the pour point of rendered fats. The selected quantity of biological-based oil may be heated at or above about 90° F. In certain embodiments, the rendered fats is heated by a heat exchanger to the second selected temperature.

The method 100 further involves, at step 106, supplying the selected quantity of rendered fats and the selected quantity of biological-based oil to a first tank, which in non-limiting embodiments, may include a general service tank car, alternatively referred to as a rail tank car or railcar, a semitruck tank, or a marine vessel holding tank. The first tank may be maintained at a temperature equal to or greater than about 90° F. The first tank may be insulated to maintain the temperature equal to or greater than 90° F. The first tank temperature may be at or above the pour point of the rendered fats. In certain embodiments, the selected quantity of rendered fats and selected quantity of biological-based oil is supplied to a first tank by a controller. The selected quantity of biological-based oil and the selected quantity of rendered fats may be supplied to the first tank simultaneously or sequentially.

In an embodiment, the first tank may include a mixing element to mix the selected quantity of rendered fats and the selected quantity of biological-based oil for a selected amount of time. The mixing element may be in the form of an agitator, a mixer mounted inside tank, or a mixing impeller. The mixing element may be controlled by a controller. The first tank may also include a heating element to maintain the third selected temperature of the blended fat composition. The heating element may be in the form of a tubular heating element, a flanged heater, coil elements, over the side heaters, a screw plug heater, and other types of heating elements. In certain embodiments, the method further includes heating the first source of rendered fats and the source of biological-based oil before supplying the selected quantity of rendered fats and the selected quantity of biological-based oil to the first tank.

While in the first tank, the method also involves the step 108 of mixing the selected quantity of rendered fats and the selected quantity of biological-based oil which forms a blended fat composition at a third selected temperature for a selected amount of time. The selected amount of time may be at least 10 minutes, at least about 15 minutes, at least about 30 minutes or even longer. The third selected temperature may be lower than the temperature of the rendered fats. The third selected temperature may be at least 90° F. The third selected temperature may be dependent on the ratio of rendered fats to biological-based oil. For example, a blended fat composition with a higher weight percent of rendered fats may have a higher third selected temperature than a blended fat composition with a lower weight percent of rendered fats. In the alternative, blended fat compositions with a lower weight percent of rendered fats may have a lower third selected temperature than a blended fat composition with a higher weight percent of rendered fats. In certain embodiments, the ratio of rendered fats to biological-based oil may be determined based on weather conditions. For example, the weight percent of rendered fats in the blended fat composition may be reduced during cold weather conditions (for example, during snow, during freezes, when ambient temperature is lower than a selected threshold, etc.). In another example, the weight percent of rendered fats in the blended fat composition may be increased during warm weather conditions (for example, when the ambient temperature is greater than a selected threshold). In certain embodiments, the ratio of rendered fats to biological-based oil DCO may be determined by the distance between the first location and the second location.

The selected quantity of rendered fats and selected quantity of biological-based oil may be supplied in different ratios. In one or more embodiments, the selected quantity of rendered fats present in the first tank may be from about 0.01 weight percent (wt. %) to about 10 wt. % of the blended fat composition. In another embodiment, the selected quantity of rendered fats present in the first tank may be from about 10 wt. % to about 20 wt. % of the blended fat composition. In another embodiment, the selected quantity of rendered fats present in the first tank may be from about 20 wt. % to about 30 wt. % of the blended fat composition. In another embodiment, the selected quantity of biological-based oil present in the first tank may be from about 70 wt. % to about 80 wt. % of the blended fat composition. In another embodiment, the selected quantity of biological-based oil present in the first tank may be from about 80 wt. % to about 90 wt. % of the blended fat composition. In another embodiment, the selected quantity of biological-based oil present in the first tank may be from about 90 wt. % to about 100 wt. % of the blended fat composition. In related embodiments, the ratio may be manipulated or adjusted to accommodate certain physicochemical features such as a desired pour point. For instance, in non-limiting embodiments where a pour point of about 100° F. is desired, the selected quantity of rendered fats in the first tank may be about 25 wt. % and the selected quantity of biological-based oil may be about 75 wt. % (resulting in a 3:1 ratio of rendered fats: biological-based oil).

At step 110 the blended fat composition is supplied to one or more transport vehicles while maintaining the third selected temperature of the blended fat composition. According to an embodiment of the present disclosure, the one or more transport vehicles may be a rail car, a freight hauler, or a marine vessel. In another embodiment, the one or more transport vehicles may each be configured to be equal to or greater than about 80° F., including equal to or great than about 90 OF to maintain the reduced pour point of the blended fat composition. In other words, a space within a tank of the transport vehicle may be held at and/or heated to a temperature of equal to or great than about 90° F. The one or more transport vehicles may be configured to maintain the reduced pour point of the blended fat composition in all weather conditions. Each transport vehicle may be insulated to maintain the third selected temperature. In another embodiment, the one or more transport vehicles may include a heating element to maintain the temperature of the blended fat composition in all weather conditions. For the rail car, the heating element may be an electric tank heater or low pressure steam provided through heat transfer coils or other forms of heating elements. Heating the marine vessel may be through plate heat exchangers, shell and tube heat exchangers, steam, or other forms of heating elements. For the freight hauler, the heating element may be a plate heat exchanger, shell and tube heat exchanger, or other forms of heating elements. Additionally, the rail car, marine vessel and/or freight hauler may be insulated using foam insulation, blanket insulation, loose-fill insulation or similar insulating compositions known to the skilled artisan. The one or more transport vehicles may include a mixer to keep the rendered fats in solution in the blended fat composition. The blended fat composition may be supplied to the one or more transport vehicles via pipe and/or flow controllers based on signals from the controller.

At step 112 the blended fat composition is transported from the first location to a second location, such as, at least about 5 miles away, 20 miles away, 50 miles away, 500 miles away, 750 miles away, 1000 miles away, 1500 miles or more away, and distances in between, while maintaining the third selected temperature. The third selected temperature may be at or above about 90° F. In some embodiments, the third selected temperature may be or may be decreased to the pour point temperature of rendered fats or the blended fat composition during transport. In other embodiments, the rendered fats and the biological-based oil (in other words, the blended fat composition) may be mixed or blended during transport from natural movement of the fluid inside the one or more transport vehicles.

At step 114 the blended fat composition is supplied, after arrival at the second location, to a second tank at a second location while maintaining the third selected temperature. The second tank, the temperature of the second tank, and/or flow to the second tank may be controlled by a controller. The second tank may be at a temperature above the third selected temperature. The second tank may be at a temperature below the third selected temperature but above the rendered fats pour point. The third selected temperature may be determined based on the distance to the second location. The third selected temperature also may be determined based on weather conditions. In another embodiment, the third selected temperature may be based on the weather conditions and/or ambient temperature, the distance to the second location from the first location, the pour point of the rendered fats, the pour point of the biological-based oil, and/or the pour point of the blended fat composition. In yet another embodiment, the third selected temperature may be adjusted (for example, by the controller) based on changes in the ambient temperature. The second tank may include a mixing element and heating element to maintain the temperature at or above about 90° F.

In one or more embodiments, the method further may include sampling the blended fat composition after mixing in the first tank to measure the pour point of the blended fat composition in accordance with the American Society for Testing and Materials (ASTM) D5950 (https://www.astm.org/d5950-14r20.html), ASTM D97-17b (https://www.astm.org/d0097-17br22.html), manual pour point, or other similar methods known to those skilled in the art. The sampling may be completed in timed intervals. In other embodiments, sampling may be completed periodically until the blended resulting fat composition pour point is below the rendered fats pour point.

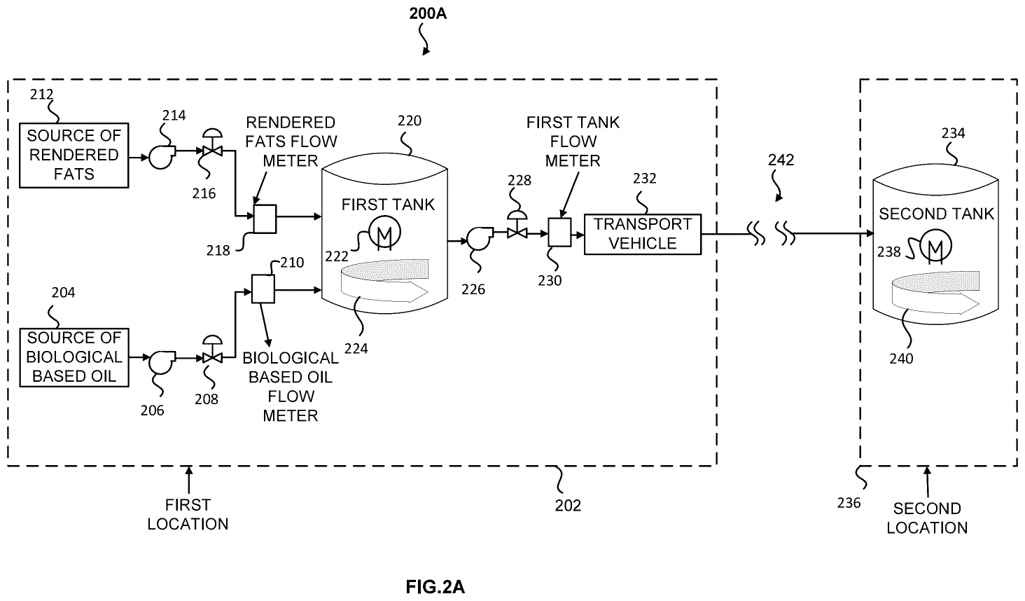

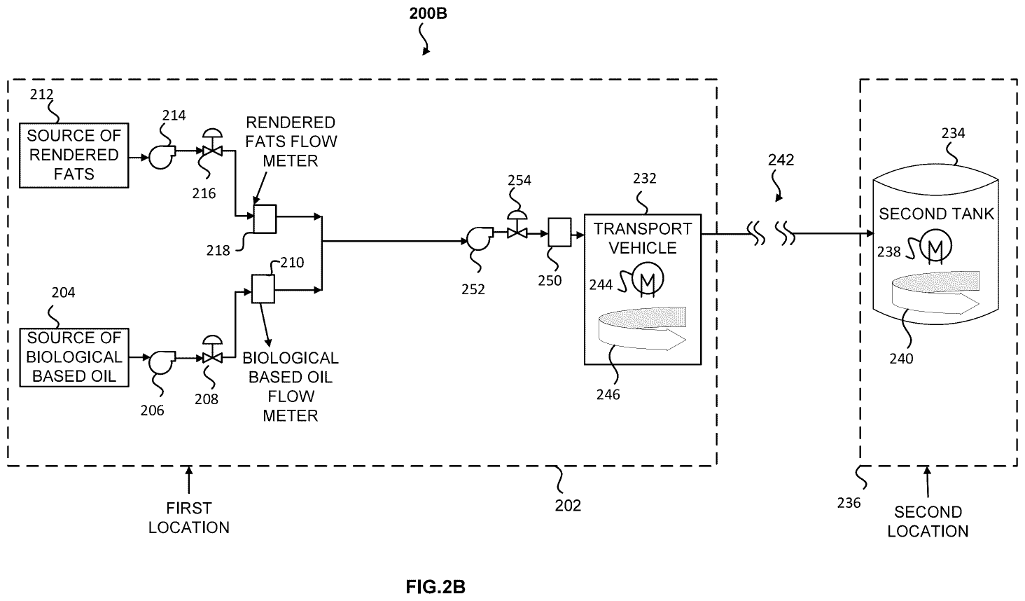

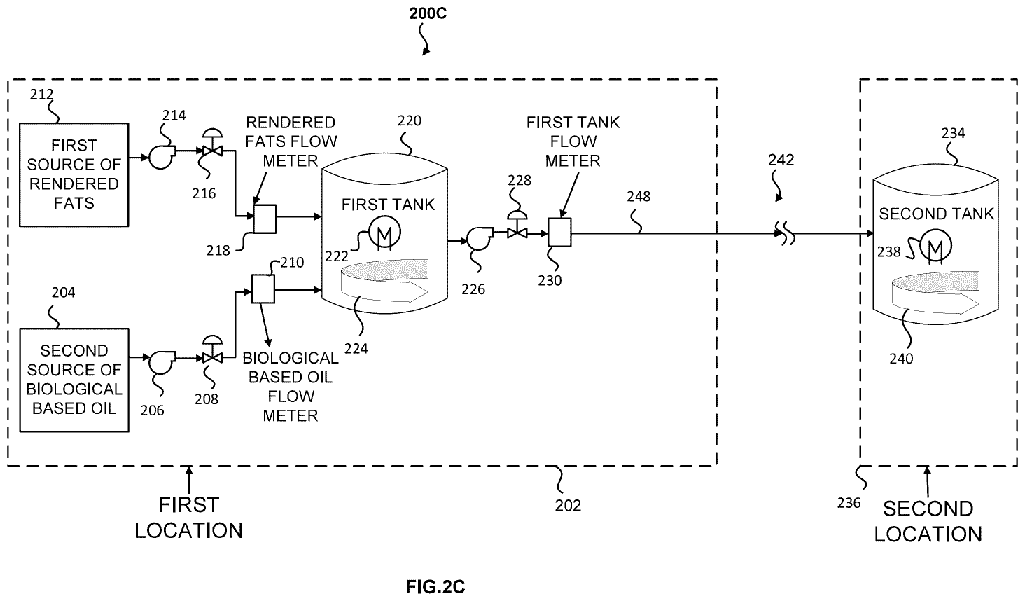

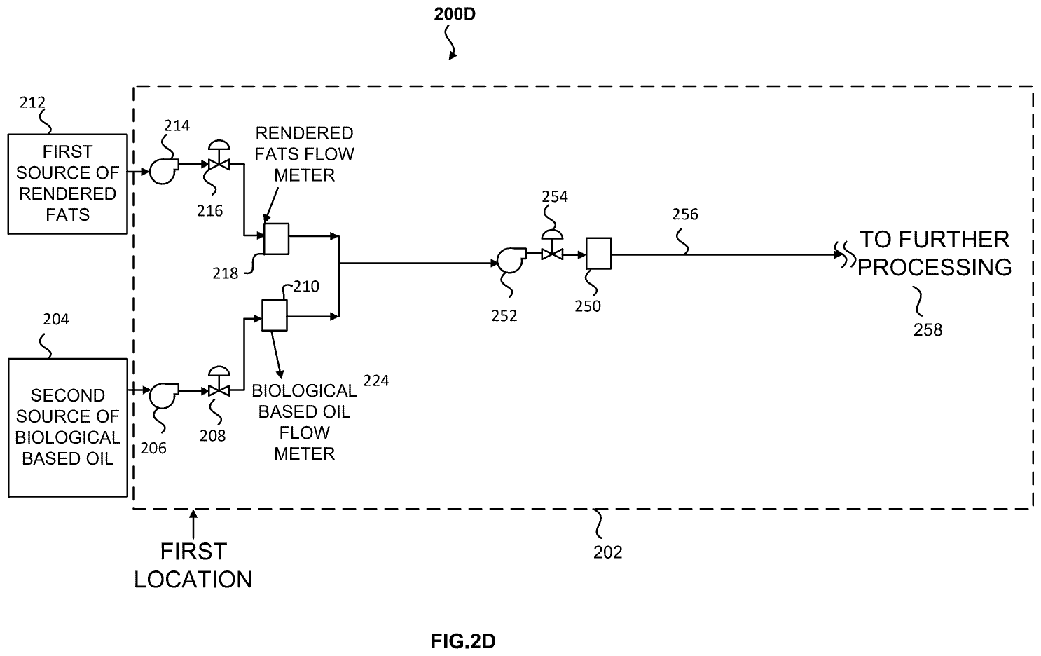

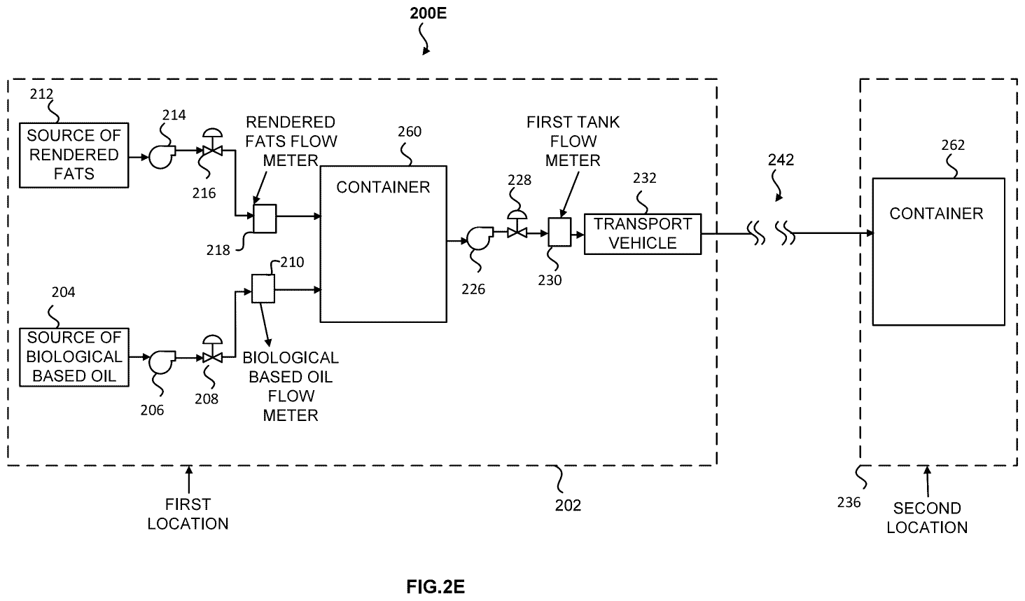

An embodiment of a system 200A for reducing the pour point for fat as described herein and as illustrated in FIG. 2A. The system 200A, for example, may be used for transporting fat from a first location to a second location. According to an embodiment of the present disclosure, the system 200 may include a first source of rendered fats 212 to supply rendered fats in a selected quantity at a first selected temperature equal to or greater than a pour point of the rendered fats. In embodiments, the first selected temperature may be equal to or greater than about 90° F. The system further includes a source of biological-based oil 204 to supply biological-based oil in a selected quantity at a second selected temperature lower than the first selected temperature and equal to or greater than a pour point of the biological-based oil. The second selected temperature may be ranging from about 90° F. to about 140° F.

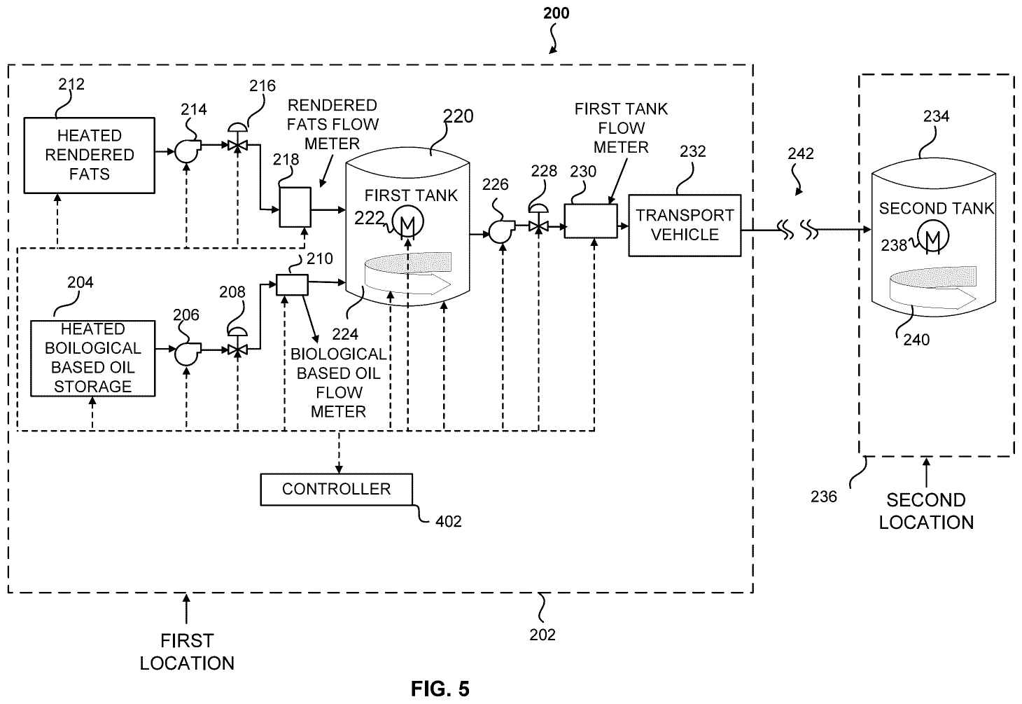

In one or more embodiments, the system 200A for reducing the pour point for a blended fat composition further includes a first tank 220 being positioned to receive the first source of rendered fats 212 and the source of biological-based oil 204 at a first location 202. The first tank 220 may include a mixing element 224 and a heating element 222 to provide the blended fat composition at a third selected temperature that has a reduced pour point that is less than the pour point of the rendered fats being supplied to the first tank 220. In embodiments, the first tank may be maintained at a temperature equal to or greater than about 90° F. The mixing element 224 and the heating element 222 may be controlled by a controller 402, as shown in FIG. 5.

Embodiments of the system 200A also includes a rendered fats pump 214 positioned between the first source of rendered fats 212 and the first tank 220. The rendered fats pump 214 is configured to supply rendered fats to the first tank 220. The rendered fats pump 214 may be controlled by a controller 402 to move fluid, as shown in FIG. 5. The embodiment of the system 200 may also include a rendered fats flow control valve 216 connected to and in fluid communication with the first source of rendered fats 212 and connected to and in fluid communication with the first tank 220. The rendered fats flow control valve 216 may be configured to supply the selected quantity of rendered fats to the first tank to create a blended fat composition. The rendered fats flow control valve 216 may be controlled by a controller 402 to adjust the flowrate, as shown in FIG. 5. The embodiment of the system 200 may further include a rendered fats flow meter 218 being disposed at a position between the rendered fats pump 214 and the first tank 220 to measure an amount of rendered fats supplied to the first tank 220 to create the blended fat composition. The rendered fats flow meter 218 may be controlled by a controller 402 to measure the flowrate, as shown in FIG. 5. The embodiment of the system 200A further includes a biological-based oil pump 206 being positioned between the source of biological-based oil 204 and the first tank 220. The biological-based oil pump 206 may be configured to supply biological-based oil to the first tank 220. The biological-based oil pump 206 may be controlled by a controller 402 to move fluid, as shown in FIG. 5.

Embodiments of the system 200A may also include a biological-based oil flow control valve 208 connected to and in fluid communication with the source of biological-based oil 204 and connected to and in fluid communication with the first tank 220. The biological-based oil flow control valve 208 may be configured to supply the selected quantity of biological-based oil 204 to the first tank 220 to create the blended fat composition. The biological-based oil flow control valve 208 may be controlled by a controller 402 to adjust the flowrate, as shown in FIG. 5. The embodiment of the system 200A may include a biological-based oil meter 210 disposed at a position between the biological-based oil pump 206 and the first tank 220 to measure an amount of biological-based oil supplied to the first tank 220 to create the blended fat composition. The biological-based oil meter 210 may be controlled by a controller 402 to measure the flowrate, as shown in FIG. 5.

In certain embodiments, an input/output is in signal communication with a first heat source. The first heat source is positioned between the first source of rendered fats and the first tank to heat a quantity of rendered fats, such that the controller is configured to adjust a first selected temperature of the quantity of rendered fats to a temperature equal to or greater than 90 degrees Fahrenheit. In certain embodiments, an input/output may be in signal communication with a second heat source. The second heat source may be positioned between the second source of biological-based oil, such as a source of DCO and the first tank to heat a quantity of the biological-based oil, such as DCO, such that the controller may be configured to adjust a second selected temperature of the quantity of biological-based oil, such as DCO to a temperature ranging from about 90 degrees Fahrenheit to about 140 degrees Fahrenheit.

Embodiments of the system 200A directed to the reduction of the pour point for rendered fats further includes one or more transport vehicles 232 positioned to transport the blended fat composition a distance or a selected distance (for example, the known distance between the first location 202 to a second a location 236) from the first location 202 to a second a location 236 while being configured to maintain the blended fat composition at the reduced pour point. The distance between the first location 202 to a second a location 236 may be greater than or equal to about 5 miles, about 20 miles, about 50 miles, about 500 miles, about 750 miles, about 1000 miles, about 1500 miles or more, and distances in between.

In certain embodiments, the one or more transport vehicles each are configured to be equal to or greater than about 90° F. (32.2° C.) to maintain the reduced pour point of the blended fat composition. The one or more transport vehicles may be selected from a rail car, a freight hauler, or a marine vessel. In certain embodiments, the one or more transport vehicles may maintain the reduced pour point of the blended fat composition in all weather conditions. Further, in another embodiment the one or more transport vehicles may be insulated using one or more of the insulation types disclosed herein. The one or more transport vehicles may further include a heating element as well as an optional agitator to maintain the third selected temperature and the consistency of the fat composition in all weather conditions.

Embodiments of system 200A further include a first tank pump 226 connected to and in fluid communication with the first tank 220 and connected to and in fluid communication with a first tank flow control valve 228. The first tank flow control valve 228 may be connected to and in fluid communication with the first tank pump 226 and connected to and in fluid communication with the one or more transport vehicles 232. The first tank flow control valve 228 may be configured to supply the blended fat composition to the one or more transport vehicles 232 to transport to a second location 236. The first tank flow control valve 228 may be controlled by a controller 402 to adjust the flowrate, as shown in FIG. 5. Embodiments of system 200A also include a first tank flow meter 230 disposed at a position between the first tank 220 and the one or more transport vehicles 232 to measure an amount of blended fat composition supplied to the one or more transport vehicles 232 to transport to a second location 236. The first tank flow meter 230 may be controlled by a controller 402 to measure the flowrate, as shown in FIG. 5.

According to an embodiment of the present disclosure, the system 200A further includes a second tank 234 being positioned to receive the blended fat composition from the one or more transport vehicles 232. The second tank 234 includes a second mixing element 240 and a second heating element 238 to maintain the blended fat composition at the reduced pour point.

In an embodiment, the mixing element 224 of the first tank 220 may be considered a mixing device. In another embodiment, other mixing devices may be utilized. Other mixing devices may include mixing elements in other mixing tanks, in-line mixing pipeline, mixing elements in a transport vehicle, and/or one or more pups and/or valves.

In certain embodiments, the system 200A may further include a heat source to heat the first source of rendered fats to the first selected temperature and the source of biological-based oil to the second selected temperature. In non-limiting embodiments, the heat source may be a heat exchanger. The heat source may be controlled by a controller to adjust the first selected temperature and the second selected temperature.

In certain embodiments, the system 200A may further include piping. In some embodiments, the piping may be insulated using commercially available pipe insulation known to those of skill in the art. The insulated piping may maintain the first selected temperature, the second selected temperature, and the third selected temperature. In another embodiment, the system 200A may further include one or more in-line heaters to maintain the first selected temperature, the second selected temperature, and the third selected temperature throughout the system 200A. The in-line heater may be controlled by a controller. One or more temperature sensors may transmit temperature readings to the controller to operate and adjust the temperature of the in-line heater.

An embodiment of a system 200B for reducing the pour point for fat as described herein and as illustrated in FIG. 2B. The system 200B, for example, may be used for transporting rendered fat (such as, in a blended fat composition) from a first location to a second location. According to an embodiment of the present disclosure, the system 200B may include a first source of rendered fats 212 to supply rendered fats in a selected quantity at a first selected temperature equal to or greater than a pour point of the rendered fats. In embodiments, the first selected temperature may be equal to or greater than about 90° F. The system further includes a source of biological-based oil 204 to supply biological-based oil in a selected quantity at a second selected temperature lower than the first selected temperature and equal to or greater than a pour point of the biological-based oil. The second selected temperature may be ranging from about 90° F. to about 140° F.

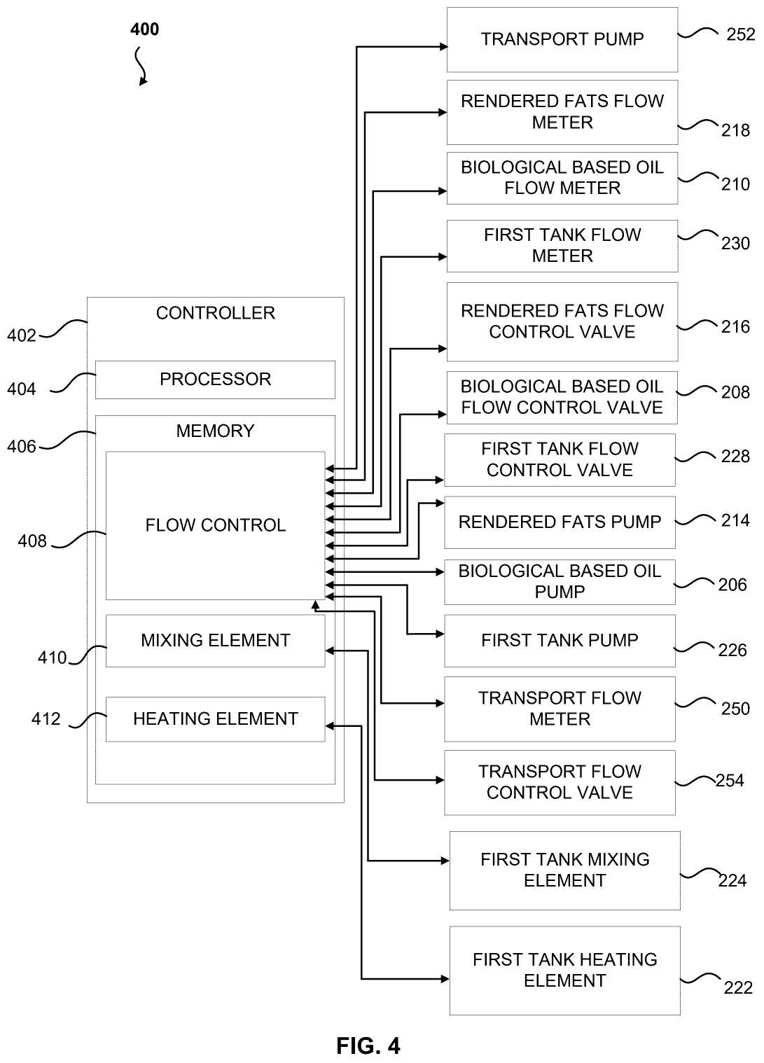

Embodiments of the system 200B also includes a rendered fats pump 214 positioned between the first source of rendered fats 212 and one or more transport vehicles 232. The rendered fats pump 214 is configured to supply rendered fats to the one or more transport vehicles 232. The rendered fats pump 214 may be controlled by a controller 402 to move fluid, as shown in FIG. 4. The embodiment of the system 200B may also include a rendered fats flow control valve 216 connected to and in fluid communication with the first source of rendered fats 212 and connected to and in fluid communication with the transport vehicle 232. The rendered fats flow control valve 216 may be configured to supply the selected quantity of rendered fats to the one or more transport vehicles 232 to create a blended fat composition. The rendered fats flow control valve 216 may be controlled by a controller 402 to adjust the flowrate, as shown in FIG. 4. The one or more transport vehicles 232 are positioned to transport and blend the rendered fats and the biological-based oil to create a blended fat composition that is transported a distance or selected distance (for example, the known distance between the first location 202 to a second a location 236) from the first location 202 to a second a location 236 while being configured to maintain the blended fat composition at the reduced pour point. The distance between the first location 202 to a second a location 236 may be greater than or equal to about 50 miles.

The embodiment of the system 200B may further include a rendered fats flow meter 218 being disposed at a position between the rendered fats pump 214 and the transport vehicle 232 to measure an amount of rendered fats supplied to the transport vehicle 232 to create the blended fat composition. The rendered fats flow meter 218 may be controlled by a controller 402 to measure the flowrate, as shown in FIG. 4. The embodiment of the system 200B further includes a biological-based oil pump 206 being positioned between the source of biological-based oil 204 and the transport vehicle 232. The biological-based oil pump 206 may be configured to supply biological-based oil to the transport vehicle 232. The biological-based oil pump 206 may be controlled by a controller 402 to move fluid, as shown in FIG. 4.

Embodiments of the system 200B may also include a biological-based oil flow control valve 208 connected to and in fluid communication with the source of biological-based oil 204 and connected to and in fluid communication with the one or more transport vehicles 232. The biological-based oil flow control valve 208 may be configured to supply the selected quantity of biological-based oil 204 to the one or more transport vehicles 232 to create the blended fat composition. The biological-based oil flow control valve 208 may be controlled by a controller 402 to adjust the flowrate, as shown in FIG. 5. The embodiment of the system 200B may include a biological-based oil meter 210 disposed at a position between the biological-based oil pump 206 and the one or more transport vehicles 232 to measure an amount of biological-based oil supplied to the one or more transport vehicles 232 to create the blended fat composition. The biological-based oil meter 210 may be controlled by a controller 402 to measure the flowrate, as shown in FIG. 5.

Embodiments of system 200B further include a transport pump 252 connected to and in fluid communication with the rendered fats flow meter 218 and the biological based oil flow meter 210 and connected to and in fluid communication with a transport flow control valve 254. The transport flow control valve 254 may be connected to and in fluid communication with the transport pump 252 and connected to and in fluid communication with the one or more transport vehicles 232. The transport flow control valve 254 may be configured to supply the rendered fats and biological based oil to the one or more transport vehicles 232 to transport to a second location 236. The transport flow control valve 254 may be controlled by a controller 402 to adjust the flowrate, as shown in FIG. 4.

Embodiments of system 200B also include a transport flow meter 250 positioned downstream of the rendered fats flow meter 218 and the biological based oil flow meter 210 and upstream of the one or more transport vehicles 232 to measure a total amount of rendered fats and biological based oil being supplied to the one or more transport vehicles 232 to transport to a second location 236. The transport flow meter 250 may be controlled by a controller 402 to measure the flowrate, as shown in FIG. 4.

The transport vehicle 232 may include a mixing element 246 and a heating element 244 to produce the blended fat composition (such as by mixing via the mixing element 246) at a third selected temperature (such as by heating via the heating element 244) that has a reduced pour point that is less than the pour point of the rendered fats being supplied to the transport vehicle 232. In embodiments, the transport vehicle 232 may maintain a temperature (such as an internal temperature via the heating element 244) equal to or greater than about 90° F. The mixing element 246 and the heating element 244 may be controlled by a controller located on the transport vehicle 232.

In certain embodiments, an input/output may be in signal communication with a third heat source. The third heat source may be positioned between the first source of rendered fats and the transport vehicle 232 to heat a quantity of rendered fats, such that the controller is configured to adjust a first selected temperature of the quantity of rendered fats to a temperature equal to or greater than 90 degrees Fahrenheit. In certain embodiments, an input/output may be in signal communication with a fourth heat source. The fourth heat source may be positioned between the second source of biological-based oil and the transport vehicle 232 to heat a quantity of biological-based oil, such that the controller is configured to adjust a second selected temperature of the quantity of biological-based oil to a temperature ranging from about 90 degrees Fahrenheit to about 140 degrees Fahrenheit.

Embodiments of the system 200B directed to the reduction of the pour point for rendered fats may further include one or more transport vehicles 232 positioned to transport the blended fat composition a distance or selected distance 242 from the first location 202 to a second a location 236 while maintaining the blended fat composition at the reduced pour point temperature. The distance between the first location 202 to a second a location 236 may be greater than or equal to about 5 miles, about 20 miles, about 50 miles, about 500 miles, about 750 miles, about 1000 miles, about 1500 miles or more, and distances in between.

In certain embodiments, each of the one or more transport vehicles are configured to be equal to or greater than about 90° F. to maintain the reduced pour point of the blended fat composition. The one or more transport vehicles may include a rail car, a freight hauler, or a marine vessel. In certain embodiments, the one or more transport vehicles may maintain the reduced pour point temperature of the blended fat composition in all weather conditions. Further, in another embodiment the one or more transport vehicles may be insulated using one or more of the insulation types disclosed herein. The one or more transport vehicles may further include a heating element as well as an optional agitator to maintain the third selected temperature and the consistency of the fat composition in all weather conditions.

According to an embodiment of the present disclosure, the system 200B further includes a second tank 234 being positioned to receive the blended fat composition from the one or more transport vehicles 232. The second tank 234 includes a second mixing element 240 and a second heating element 238 to maintain the blended fat composition at the reduced pour point.

In certain embodiments, the system 200B may further include piping. In some embodiments, the piping may be insulated using commercially available pipe insulation known to those of skill in the art. The insulated piping may maintain the first selected temperature, the second selected temperature, and/or the third selected temperature. In another embodiment, the system 200B may further include one or more in-line heaters and/or heat tracing to maintain the first selected temperature, the second selected temperature, and the third selected temperature throughout the system 200B. The in-line heater may be controlled by a controller. One or more temperature sensors may transmit temperature readings to the controller to operate and adjust the temperature of the in-line heater.

An embodiment of a system 200C for reducing the pour point for fat is illustrated in FIG. 2C. The system 200C, for example, may be used for transporting fat from a first location to a second location. According to an embodiment of the present disclosure, the system 200C may include a first source of rendered fats 212 to supply rendered fats in a selected quantity at a first selected temperature equal to or greater than a pour point of the rendered fats. In embodiments, the first selected temperature may be equal to or greater than about 90° F. The system further includes a source of biological-based oil 204 to supply biological-based oil in a selected quantity at a second selected temperature lower than the first selected temperature and equal to or greater than a pour point of the biological-based oil. The second selected temperature may be ranging from about 90° F. to about 130° F.

In one or more embodiments, the system 200C for reducing the pour point for a blended fat composition further includes a first tank 220 being positioned to receive the first source of rendered fats 212 and the source of biological-based oil 204 at a first location 202. The first tank 220 may include a mixing element 224 and a heating element 222 to provide the blended fat composition at a third selected temperature that has a reduced pour point that is less than the pour point of the rendered fats being supplied to the first tank 220. In embodiments, the first tank may be maintained at a temperature equal to or greater than about 90° F. The mixing element 224 and the heating element 222 may be controlled by a controller 402, as shown in FIG. 5.

Embodiments of the system 200C also includes a rendered fats pump 214 positioned between the first source of rendered fats 212 and the first tank 220. The rendered fats pump 214 is configured to supply rendered fats to the first tank 220. The rendered fats pump 214 may be controlled by a controller 402 to move fluid, as shown in FIG. 5. The embodiment of the system 200 may also include a rendered fats flow control valve 216 connected to and in fluid communication with the first source of rendered fats 212 and connected to and in fluid communication with the first tank 220. The rendered fats flow control valve 216 may be configured to supply the selected quantity of rendered fats to the first tank to create a blended fat composition. The rendered fats flow control valve 216 may be controlled by a controller 402 to adjust the flowrate, as shown in FIG. 5. The embodiment of the system 200C may further include a rendered fats flow meter 218 being disposed at a position between the rendered fats pump 214 and the first tank 220 to measure an amount of rendered fats supplied to the first tank 220 to create the blended fat composition. The rendered fats flow meter 218 may be controlled by a controller 402 to measure the flowrate, as shown in FIG. 5. The embodiment of the system 200C further includes a biological-based oil pump 206 being positioned between the source of biological-based oil 204 and the first tank 220. The biological-based oil pump 206 may be configured to supply biological-based oil to the first tank 220. The biological-based oil pump 206 may be controlled by a controller 402 to move fluid, as shown in FIG. 5.

Embodiments of the system 200C may also include a biological-based oil flow control valve 208 connected to and in fluid communication with the source of biological-based oil 204 and connected to and in fluid communication with the first tank 220. The biological-based oil flow control valve 208 may be configured to supply the selected quantity of biological-based oil 204 to the first tank 220 to create the blended fat composition. The biological-based oil flow control valve 208 may be controlled by a controller 402 to adjust the flowrate, as shown in FIG. 5. The embodiment of the system 200C may include a biological-based oil meter 210 disposed at a position between the biological-based oil pump 206 and the first tank 220 to measure an amount of biological-based oil supplied to the first tank 220 to create the blended fat composition. The biological-based oil meter 210 may be controlled by a controller 402 to measure the flowrate, as shown in FIG. 5.

In certain embodiments, an input/output is in signal communication with a fifth heat source. The fifth heat source is positioned between the first source of rendered fats and the pipeline 248 to heat a quantity of rendered fats, such that the controller is configured to adjust a first selected temperature of the quantity of rendered fats to a temperature equal to or greater than 90 degrees Fahrenheit. In certain embodiments, an input/output is in signal communication with a sixth heat source. The sixth heat source is positioned between the second source of biological-based oil and the pipeline 248 to heat a quantity of biological-based oil, such that the controller is configured to adjust a second selected temperature of the quantity of biological-based oil to a temperature ranging from about 90 degrees Fahrenheit to about 130 degrees Fahrenheit.

Embodiments of system 200C further include a first tank flow control valve 228 connected to and in fluid communication with the first tank 220 and connected to and in fluid communication with a pipeline 248. The first tank flow control valve 228 may be configured to supply the blended fat composition to the pipeline 248 to transport to a second location 236. The first tank flow control valve 228 may be controlled by a controller 402 to adjust the flowrate, as shown in FIG. 5.

The pipeline 248 is positioned to transport the blended fat composition a distance or selected distance from the first location 202 to a second a location 236 while being configured to maintain the blended fat composition at the reduced pour point. The second location may be a distance or selected distance 242 of at least 5 miles away, 15 miles away, 50 miles away, 100 miles away, 300 miles away, 500 miles away, 750 miles away, 1200 miles away, 1500 miles away or more, and distances in between from the first location.

In certain embodiments, the pipeline further may include one or more heat tracing elements so that the temperature of the pipeline is equal to or greater than about 90° F. to maintain the reduced pour point of the blended fat composition. In certain embodiments, the pipeline may maintain the reduced pour point temperature of the blended fat composition in all weather conditions.

Embodiments of system 200C also include a first tank flow meter 230 positioned between the first tank 220 and the pipeline 248 to measure an amount of blended fat composition supplied to the pipeline 248 to transport to a second location 236. The first tank flow meter 230 may be controlled by a controller 402 to measure the flowrate, as shown in FIG. 5.

According to an embodiment of the present disclosure, the system 200C further includes a second tank 234 being positioned to receive the blended fat composition from the pipeline 248. The second tank 234 includes a second mixing element 240 and a second heating element 238 to maintain the blended fat composition at the reduced pour point.

In certain embodiments, the system 200C may further include piping (for example, pipeline 248 and/or other piping internal and/or external to the first location 202 and/or second location 236). In some embodiments, the piping may be insulated using commercially available pipe insulation known to those of skill in the art. The insulated piping may maintain the first selected temperature, the second selected temperature, and the third selected temperature. In another embodiment, the system 200C may further include one or more in-line heaters to maintain the first selected temperature, the second selected temperature, and the third selected temperature throughout the system 200C. The in-line heater may be controlled by a controller. One or more temperature sensors may transmit temperature readings to the controller to operate and adjust the temperature of the in-line heater.

An embodiment of a system 200D for reducing the pour point for fat as described herein and as illustrated in FIG. 2D. The system 200D, for example, may be used for transporting fat from a first location to a second location. According to an embodiment of the present disclosure, the system 200D may include a first source of rendered fats 212 to supply rendered fats in a selected quantity at a first selected temperature equal to or greater than a pour point of the rendered fats. In embodiments, the first selected temperature may be equal to or greater than about 90° F. The system further includes a source of biological-based oil 204 to supply biological-based oil in a selected quantity at a second selected temperature lower than the first selected temperature and equal to or greater than a pour point of the biological-based oil. The second selected temperature may be ranging from about 90° F. to about 130° F.

Embodiments of the system 200D also includes a rendered fats pump 214 positioned between the first source of rendered fats 212 and downstream further processing equipment 258. The rendered fats pump 214 is configured to supply rendered fats to downstream further processing equipment 258. The rendered fats pump 214 may be controlled by a controller 402 to move fluid, as shown in FIG. 4. The embodiment of the system 200D may also include a rendered fats flow control valve 216 connected to and in fluid communication with the first source of rendered fats 212 and connected to and in fluid communication with the downstream further processing equipment 258. The rendered fats flow control valve 216 may be configured to supply the selected quantity of rendered fats to the downstream further processing equipment 258 to create a blended fat composition. The rendered fats flow control valve 216 may be controlled by a controller 402 to adjust the flowrate, as shown in FIG. 4. The downstream further processing equipment 258 may be configured to blend the rendered fats and the biological-based oil to create a blended fat composition. In other embodiments, the pipeline 256 may include an in-line mixing component, element, and/or device. The pipeline 256 may mix the biological-based oil and the rendered fats to form the blended fat composition. Further, the pipeline 256 may include in-line heating and/or heat tracing elements to maintain the temperature of the blended fat composition.

The embodiment of the system 200D may further include a rendered fats flow meter 218 being disposed at a position between the rendered fats pump 214 and the downstream further processing equipment 258 to measure an amount of rendered fats supplied to the downstream further processing equipment 258 to create the blended fat composition. The rendered fats flow meter 218 may be controlled by a controller 402 to measure the flowrate, as shown in FIG. 4. The embodiment of the system 200D further includes a biological-based oil pump 206 being positioned between the source of biological-based oil 204 and the downstream further processing equipment 258. The biological-based oil pump 206 may be configured to supply biological-based oil to the downstream further processing equipment 258. The biological-based oil pump 206 may be controlled by a controller 402 to move fluid, as shown in FIG. 4.

Embodiments of the system 200B may also include a biological-based oil flow control valve 208 connected to and in fluid communication with the source of biological-based oil 204 and connected to and in fluid communication with the downstream further processing equipment 258. The biological-based oil flow control valve 208 may be configured to supply the selected quantity of biological-based oil 204 to the downstream further processing equipment 258 to create the blended fat composition. The biological-based oil flow control valve 208 may be controlled by a controller 402 to adjust the flowrate, as shown in FIG. 4. The embodiment of the system 200B may include a biological-based oil meter 210 disposed at a position between the biological-based oil pump 206 and the downstream further processing equipment 258 to measure an amount of biological-based oil supplied to the downstream further processing equipment 258 to create the blended fat composition. The biological-based oil meter 210 may be controlled by a controller 402 to measure the flowrate, as shown in FIG. 4.

Embodiments of system 200D further include a transport pump 252 connected to and in fluid communication with the rendered fats flow meter 218 and the biological based oil flow meter 210 and connected to and in fluid communication with a transport flow control valve 254. The transport flow control valve 254 may be connected to and in fluid communication with the transport pump 252 and connected to and in fluid communication with the downstream further processing equipment 258. The transport flow control valve 254 may be configured to supply the rendered fats and biological based oil to the downstream further processing equipment. The transport flow control valve 254 may be controlled by a controller 402 to adjust the flowrate, as shown in FIG. 4.

Embodiments of system 200D also include a transport flow meter 250 positioned downstream of the rendered fats flow meter 218 and the biological based oil flow meter 210 and upstream of the downstream further processing equipment 258 to measure a total amount of rendered fats and biological based oil being supplied to the downstream further processing equipment 258. The transport flow meter 250 may be controlled by a controller 402 to measure the flowrate, as shown in FIG. 4.

In certain embodiments, an input/output is in signal communication with a seventh heat source. The seventh heat source is positioned between the first source of rendered fats and the downstream further processing equipment 258 to heat a quantity of rendered fats, such that the controller is configured to adjust a first selected temperature of the quantity of rendered fats to a temperature equal to or greater than 90 degrees Fahrenheit. In certain embodiments, an input/output is in signal communication with an eighth heat source. The eighth heat source is positioned between the second source of biological-based oil and downstream further processing equipment 258 to heat a quantity of biological-based oil, such that the controller is configured to adjust a second selected temperature of the quantity of biological-based oil to a temperature ranging from about 90 degrees Fahrenheit to about 130 degrees Fahrenheit.

In certain embodiments, the system 200D may further include piping. In some embodiments, the piping may be insulated using commercially available pipe insulation known to those of skill in the art. The insulated piping may maintain the first selected temperature, the second selected temperature, and the third selected temperature. In another embodiment, the system 200D may further include one or more in-line heaters to maintain the first selected temperature, the second selected temperature, and the third selected temperature throughout the system 200D. The in-line heater may be controlled by a controller. One or more temperature sensors may transmit temperature readings to the controller to operate and adjust the temperature of the in-line heater.

In another embodiment, the first location 202 may be or may include one or more of a refinery, fuel processing facility, farm, rendered fat source, or biological-based oil source, and the second location 236 may be or may include one or more of a refinery, fuel processing facility, or a renewable transportation fuel processing location. Further processing of the blended fat composition at a fuel processing facility may include processing the blended fat composition into one or more of renewable diesel, naphtha, propane, treated fuel gas, jet renewable fuel, sustainable aviation kerosene, hydro processed esters.

As illustrated in FIG. 2D, the rendered fat and biological-based oil may be blended (for example, to form the blended fat composition) at the first location 202 and transported to another location internal to the first location 202 (for example, intra-refinery transportation via piping and/or transport vehicles) and/or external to the first location 202 (as illustrated in, for example, FIGS. 2A-2C).

In another embodiment, the blended fat composition may be stored at any time during production in a container, such as a tank, pit, trough, and/or other storage area configured to maintain a specified temperature range (such as above the reduced pour point of the blended fat composition). As illustrated in FIG. 2E, the first location 202 may include a container 260 to store the blended fat composition. In other embodiments, the container 260 may include a heating element (for example, to maintain temperature of the blended fat composition) and/or a mixing element (for example, to produce the blended fat composition or ensure that the blended fat composition remains blended). Further, the blended fat composition may be transported (for example, via a transport vehicle 232 or pipeline) to a second location 236. The second location 236 may include a container 262 (such as a tank, pit, trough, and/or other storage area configured to maintain a specified temperature range). In such an embodiment, the blended fat composition may be stored in the container 236. In other embodiments, the blended fat composition may be transported directly for use within the second location 236, rather than being stored in a container. In yet another embodiment, a portion of the blended fat composition may be used directly, while another portion of the blended fat composition may be stored for later use (for example, in container 262).

As illustrated in FIG. 5, the system may include a controller 402. The controller 402 may connect to or be in signal communication with various different sensors, other controllers, meters, or components. In another example, the controller 402 may be a controller for use in a fuel processing facility, e.g., a fuel processing facility controller, as will be understood by those skilled in the art, and may include computer programs, program logic, and/or software code or instructions, in addition to the instructions described below, to control various fuel processing facility processes and/or equipment. The controller 402 may include memory and one or more processors. The memory may store instructions executable by the one or more processors. In an example, the memory may be a machine-readable storage medium. As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. As noted, the memory may store or include instructions executable by the processor. As used herein, a “processor” may include, for example one processor or multiple processors included in a single device or distributed across multiple computing devices. The processor may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As used herein, “signal communication” refers to electric communication such as hard wiring two components together or wireless communication, as understood by those skilled in the art. For example, wireless communication may be Wi-Fi®, Bluetooth®, ZigBee, or forms of near-field communications. In addition, signal communication may include one or more intermediate controllers or relays disposed between elements that are in signal communication with one another. In an embodiment, the controller 402 may include a plurality of inputs, outputs, and/or input/outputs. The controller 402 may connect to the various components or devices described herein via the plurality of inputs, outputs, and/or input/outputs.

In such examples, the controller 402 may determine whether to and/or to what to adjust a flowrate of the selected quantity of rendered fats 212 and the selected quantity of biological-based oil 204 to combine at the first tank 220 in systems 200A, 200B, 200C. The controller may receive measurements from the rendered fats flow meter that measures the flow rate from the source of the rendered fats. The controller also may receive measurements from the biological-based oil flow meter that measures the flow rate from the source of the biological-based oil. The controller may further receive measurements from the first tank flow meter measuring the flow rate from the source of the first tank. The controller may further determine whether to and/or to what to adjust the flowrate of the blended fat composition to provide to one or more transport vehicles 232.

In embodiments, for example, the controller 402 of systems 200A, 200B, 200C, 200D may control the rendered fats flow control valve 216. The controller 402 in response to the flowrate measured from the rendered fats flow meter 218 may open or close the rendered fats flow control valve 216 to a select percentage open to obtain the selected rendered fats ratio in the blended fat composition. The controller 402 of system 200 may also control the biological-based oil flow control valve 208. The controller 402 in response to the flowrate measured from the biological-based oil flow meter 210 may open or close the biological-based oil flow control valve 208 to a select percentage open to obtain the selected biological-based oil ratio in the blended fat. The controller 402 of systems 200A, 200B, 200C, 200D may also control the first tank flow control valve 228. The controller 402 in response to the flowrate measured from the first tank flow meter 230 may open or close the first tank flow control valve 228 to a select percentage open to supply an amount of blended fat to the one or more transport vehicles 232, or the pipeline 248.

In another example, the controller 402 may determine whether to and/or to what to adjust the speed of the biological-based oil pump 206 and the rendered fats pump 214, and the first tank pump 226, thereby modifying the flowrate of the selected quantity of rendered fats 212 and the selected quantity of biological-based oil 204 to combine at the first tank 220. The controller may further determine whether to and/or to what to adjust the speed of the biological-based oil pump 206 and the rendered fats pump 214, and the first tank pump 226 thereby modifying the flowrate of the blended fat composition to the one or more transport vehicles 232. The controller 402 in response to the flowrate measured from the rendered fats flow meter 218 may vary the speed or continuously pump the rendered fats through the rendered fats pump 214 to obtain the rendered fats ratio in the blended fat. The controller 402 in response to the flowrate measured from the biological-based oil flow meter 210 may vary the speed or continuously pump the biological-based oil through the biological-based oil pump 206 to obtain the DCO ratio in the blended fat.

In certain embodiments in systems 200A and 200C, the controller 402 in response to the flowrate measured from the first tank flow meter 230 may vary the speed or continuously pump the blended fat composition through the first tank pump 226 to supply an amount of blended fat to the one or more transport vehicles 232. In certain embodiments in system 200B, the controller 402 in response to the flowrate measured from the transport flow meter 250 may vary the speed or continuously pump the blended fat composition through the first tank pump 226 to supply an amount of blended fat to the one or more transport vehicles 232. The controller in response to the temperature measured in the piping may adjust the temperature of in-line heaters or other heating forms for the piping.

In another example, the controller 402 of systems 200A and 200C may further be configured to obtain the flowrate from the first tank flow meter 230 after initiation of the first tank pump 226. In another example, the controller 402 of systems 200A, 200B, 200C, 200D may further be configured to obtain the flowrate from the rendered fats flow meter 218 after initiation of the rendered fats pump 214. The controller 402 of the systems 200A, 200B, 200C, 200D may also be configured to obtain the flowrate from the biological-based oil flow meter 210 after initiation of the biological-based oil pump 206.

In another example, the controller 402 of systems 200A and 200C, may control the operability of the mixing element 224 at the first tank 220. The mixing element 224 may be used continuously or may be used selectively for a selected time period. The selected time period may depend on the amount of blended fat in the first tank. The selected time period may depend on the temperature of the blended fat, as will be understood by those skilled in the art.

In another example, the controller 402 of systems 200A and 200C, may determine whether to and/or to what to adjust the first tank temperature to, to maintain the third selected temperature of the blended fat composition at the reduced pour point. The controller 402 may adjust the heating element in the first tank. Sensors may detect a temperature of the blended fat in the first tank. Temperatures below or at the pour point may signal the controller to adjust the heating element temperature.

FIG. 4 is a simplified diagram illustrating a control system or systems 200A, 200B, 200C, 200D for operatively controlling the reduction of the pour point of render fats and transporting the fat from a first location to a second location, according to an embodiment of the disclosure. As noted above, the controller 502 may include memory 406 and a processor 404 (or one or more processors). The memory 406 may store instructions and the instructions may be executable by the processor 404. The instructions may include instructions 408 to control the flow control valves and other components (for example, meters, pumps) to control or adjust the flow rate of the fluids. The controller 402 may control a rendered fats flow control valve 216, a rendered fats flow meter 218, and a rendered fats pump 214 between the first source of rendered fats and the first tank. The controller 402 may control a biological-based oil flow control valve 208, a biological-based oil flow meter 210, and a biological-based oil pump 206 between the source of biological-based oil and the first tank. The controller 402 of systems 200A and 200C, may also control a first tank flow control valve 228, a first tank flow meter 230, and a first tank pump 226 between the first tank and the one or more transport vehicles.

The controller 402 may also include computer programs or software code or instructions 410, as will be understood by those skilled in the art, to control a mixing element 224 in the first tank. The controller 402 may further include instructions 412 to control a heating element in the first tank.

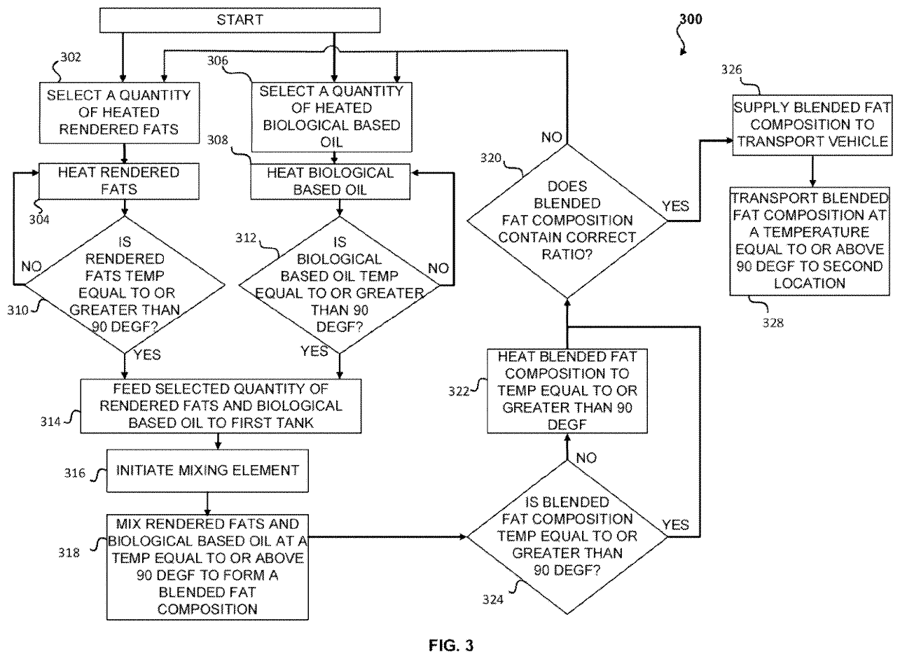

FIG. 3 is a flow diagram of an embodiment of a method, such as instructions implemented in a controller as understood by those skilled in the art, for reducing the pour point of render fats and transporting the fat from a first location to a second location, according to an embodiment. The method, for example, also is described with reference to system 200A of FIG. 2A. Unless otherwise specified, the actions of method 300 may be implemented by the controller 402, as will be understood by those skilled in the art. Specifically, method 300 may be included in one or more computer programs, protocols, or instructions loaded into the memory of the controller 402 and executed on the processor or one or more processors of the controller 402. The order in which the operations are described is not intended to be construed as a limitation, and any number of the described blocks may be combined in any order and/or in parallel to implement the methods.

The method 300 may be initiated, for example, by a user interface connected to the controller 402, or responsive to certain determinations or other system detections, by selecting at block 302 a quantity of rendered fats and selecting a quantity of biological-based oil at block 306. At block 304, in response to a signal, the controller 402 may determine a temperature to heat the rendered fats and send a signal to heat the rendered fats from the first source of rendered fats. Similarly, at block 308, in response to a signal, the controller 402 may determine a temperature to heat the biological-based oil and send a signal to heat the biological-based oil from the source of biological-based oil. After heating the rendered fats and the biological-based oil for a sufficient amount of time, at block 310, the controller 402 may determine (for example, via a sensor) whether the rendered fats are at a sufficient or correct temperature above the pour point and/or above about 90° F. If the rendered fats are not at a sufficient or correct temperature above the pour point, the controller may send a signal for the rendered fats to undergo additional heating, at block 304. Similarly, at block 312, the controller 402 may determine (for example, via a sensor) whether the biological-based oil is at a sufficient or correct temperature above the pour point and/or above about 90° F. If the biological-based oil is not at a sufficient or correct temperature above the pour point, the controller may send a signal for the biological-based oil to undergo additional heating, at block 308.

At block 314, the rendered fats and the biological-based oil are fed into the first tank. At block 316, in response to a signal, the controller may initiate a mixing element within the first tank. The rendered fats and the biological-based oil may be mixed for a sufficient time. As such, at block 320, the controller 402 may determine (for example, via a sensor) whether the blended fat composition pour point temperature is less than the pour point of rendered fats. If the blended fat composition pour point is not less than pour point of rendered fat, at block 322, additional biological-based oil may be added where at block 306, a selected quantity of biological-based oil is heated at block 308 as described herein. Blended fat composition that has a pour point less than the pour point of rendered fats, at block 324, may be supplied to a transport vehicle. At block 326, the transport vehicle may then transport the fat at a temperature above about 90° F. to a second location.

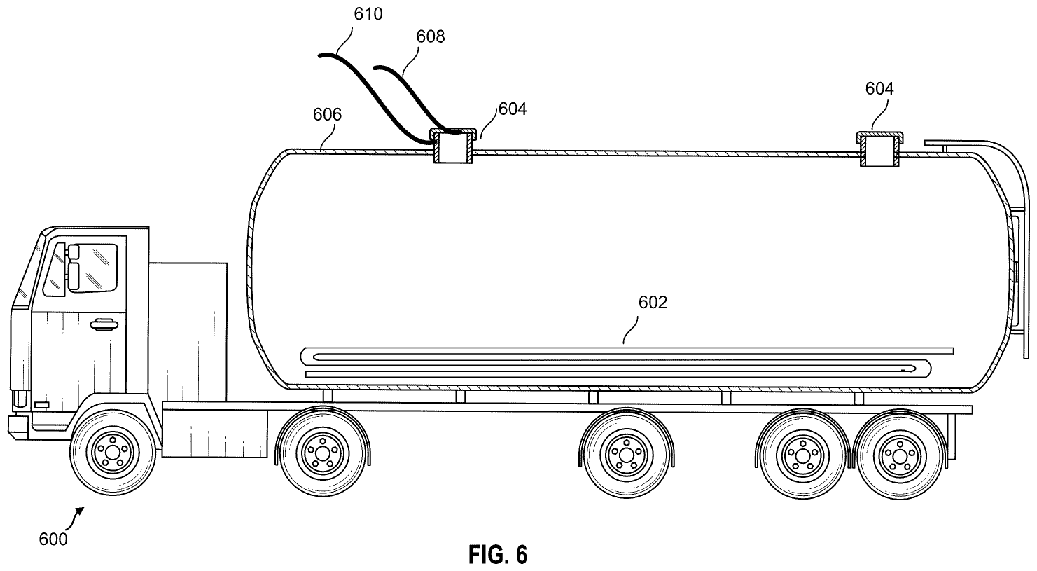

FIGS. 6-8 are schematic diagram illustrations of an embodiment of the production of fat with a reduced pour point transported from a first location to a second location, according to an embodiment of the disclosure. The transport vehicle may be a freight hauler, rail car, or a marine vessel. For example, as shown in FIG. 6, a transport vehicle such as a freight hauler 600 may transport the blended fat from the first location to a second location. The blended fat may be loaded onto the freight hauler using a hose 608 or other loading structures or apparatuses, as will be understood by those skilled in the art. The second location, for example, may be positioned many miles (such as, at least about 50 miles, and may range from about 50 miles to about 1000 miles or more, including about 500 miles, about 600 miles and about 800 miles) from the first location. The freight hauler may be insulated using insulation 606 to keep the blended fat composition in solution at the third selected temperature. The freight hauler may have a heating element 602 to maintain the third temperature. If the third selected temperature decreases, the heating element will heat the blended fat to the third selected temperature. The blended fat may be offloaded at the second location from a port 604 using an unloading structure 610. As used herein, the unloading structure may be a hose or an apparatus, such as a conduit, line, or pipe.

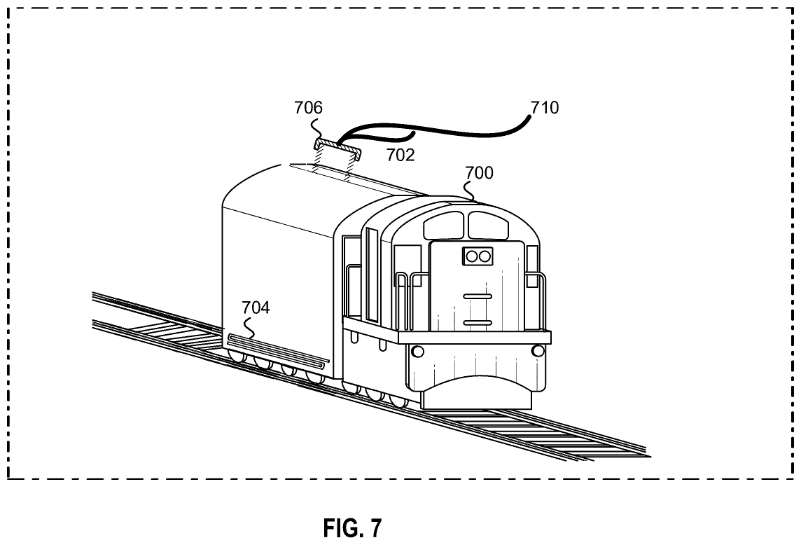

In another example, as shown in FIG. 7, a rail car 700 may transport the blended fat from the first location to a second location. The blended fat may be loaded onto the rail car using a hose 702 or other loading structures or apparatuses, as will be understood by those skilled in the art. The second location, for example, may be positioned many miles (such as, at least about 50 miles, and may range from about 50 miles to about 1000 miles or more, including about 500 miles, about 600 miles and about 800 miles) from the first location. The rail car may be insulated to keep the blended fat in solution at the third selected temperature. The rail car may have a heating element 704 to maintain the third temperature. The heating element may be a steam generator, an electric infrared (IR) heater, or a gas-fired radiant heater. If the third selected temperature decreases, the heating element will heat the blended fat to the third selected temperature. The blended fat may be offloaded at the second location from a port 706 using an unloading structure 710.

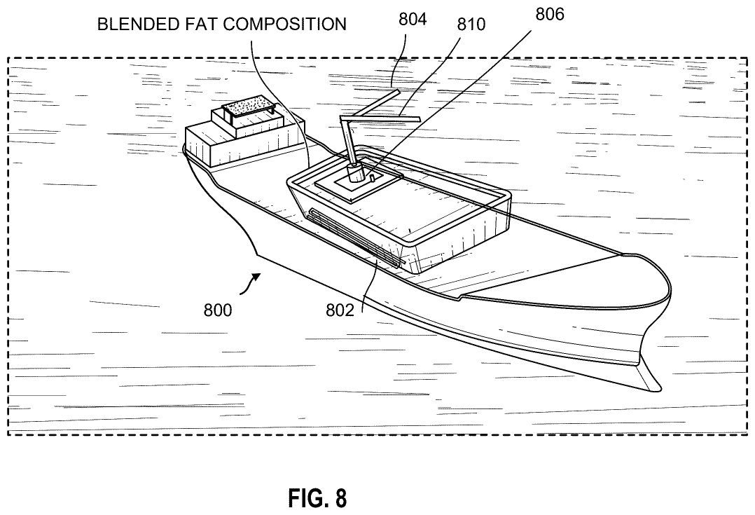

In another example, as shown in FIG. 8, a marine vessel 800 may transport the blended fat from the first location to a second location. The blended fat may be loaded onto the marine vessel using a hose 804 or other loading structures or apparatuses, as will be understood by those skilled in the art. The second location, for example, may be positioned many miles (such as, at least 50 miles, and may range from 50 miles to about 1000 miles or more, including about 500 miles, about 600 miles and about 800 miles) from the first location. The marine vessel may be insulated to keep the blended fat in solution at the third selected temperature. The marine vessel may have a heating element 802 to maintain the third temperature. The heating element may be a steam generator, an electric infrared (IR) heater, or a gas-fired radiant heater. If the third selected temperature decreases, the heating element will heat the blended fat to the third selected temperature. The blended fat may be offloaded at the second location from a port 806 using an unloading structure 810.

Although specific terms are employed herein, the terms are used in a descriptive sense only and not for purposes of limitation. Embodiments of systems and methods have been described in considerable detail with specific reference to the illustrated embodiments. However, it will be apparent that various modifications and changes can be made within the spirit and scope of the embodiments of systems and methods as described in the foregoing specification, and such modifications and changes are to be considered equivalents and part of this disclosure.

### EXPERIMENTAL

Tests were carried out to evaluate the pour point of the blended fat compositions at various temperatures at varying ratios of the fat and DCO in the blended fat composition. Additionally, the cloud point and viscosity were also measured. The varying ratios of fat composition and DCO in the blended fat composition pour points were also compared to the pour point, cloud point, and viscosity of fat and DCO to evaluate the effectiveness of the blended fat compositions in reducing the pour point of rendered fats. Test results are shown in Table 2.

### Example

Multiple blends of blended fat compositions were developed using DCO and technical tallow at varying ratios and temperature. The blends included biological-based oils and rendered fats exemplified in Table 1 below, which further discloses the pour point (PP, in both degrees Celsius (° C.) and Fahrenheit (° F.)) and well as the melting point (MP, in ° F.). Blends included 5% tallow and 95% DCO, 10% tallow and 90% DCO, 15% tallow and 85% DCO, 20% tallow and 80% DCO, and 25% tallow and 75% DCO. All blends were made by weight percent. The DCO used in testing was from a first site/location tank 1081, and technical tallow was sourced from a remote vendor.

TABLE 1

| Rendered Fats/Oils | PP(º C.) | PP(º F.) | MP(° F.) |
|---|---|---|---|
| Canola | −26 | −15 | |
| Soybean Oil | −10 | 14 | |
| UCO | −5 | 23 | |
| 20% UCO/80% Pork Fat | 9 | 48 | 77 |
| Poultry Fat solid | 1 | 34 | 106 |
| CWG | 20 | 68 | 91 |
| Pork CWG | 23 | 73 | 93 |
| Brown Grease | 26 | 79 | 90 |
| Yellow Grease | 29 | 84 | 91 |
| Lard Pork fat | | | 93 |
| Refined Beef Tallow | | | 109 |
| Inedible and Polished Tallow | | | 113 |
| Lard Pork fat | | | 120 |

Testing began with tallow at 75° F., at which temperature the tallow remained solid. The tallow was next mixed with DCO in a 25% tallow, 75% DCO ratio but the tallow remained solid and required scraping out of the container. As such, the tallow did not go into solution at 75° F. The 25% tallow, 75% DCO ratio was then heated up to 100° F. for one hour without mixing. After approximately one hour, the tallow was in solution. At 100° F., although the tallow was fluid, solids remained within the testing sample. Additionally, the solids remain within the blended tallow despite the addition of DCO. The testing sample was again mixed and placed in a 100° F. water bath for approximately 30 minutes. After 30 minutes, the blended tallow was completely homogenized.

Another sample blended tallow was created at 125° F. which included mixing the tallow and DCO. The blended tallow was fluid and in solution with no visible solids at this temperature. A small observation study was conducted allowing the 125° F. blends to sit at about 60° F. for 36 hours. After 36 hours, the blended tallow was no longer in solution.

The test samples of various ratio blends were carried out to test the cloud point, pour point, American Petroleum Institute (API) gravity, and viscosity of the various blended tallows at 100° F. and 125° F. However, only the 100° F. blends were analyzed for API gravity at 60° F. The test samples were heated to 140° F. prior to injection into the instrument to avoid the tallow setting up within the measurement cell.

Testing to evaluate the pour point of blended tallows at varying ratios of the rendered fats and DCO in the blended tallows was conducted in one-degree (1°) increments, as compared to diesel which is normally conducted at 5° increments for pour point determination. Pour point testing was carried out in accordance with ASTM D5950, as will be understood by those skilled in the art.

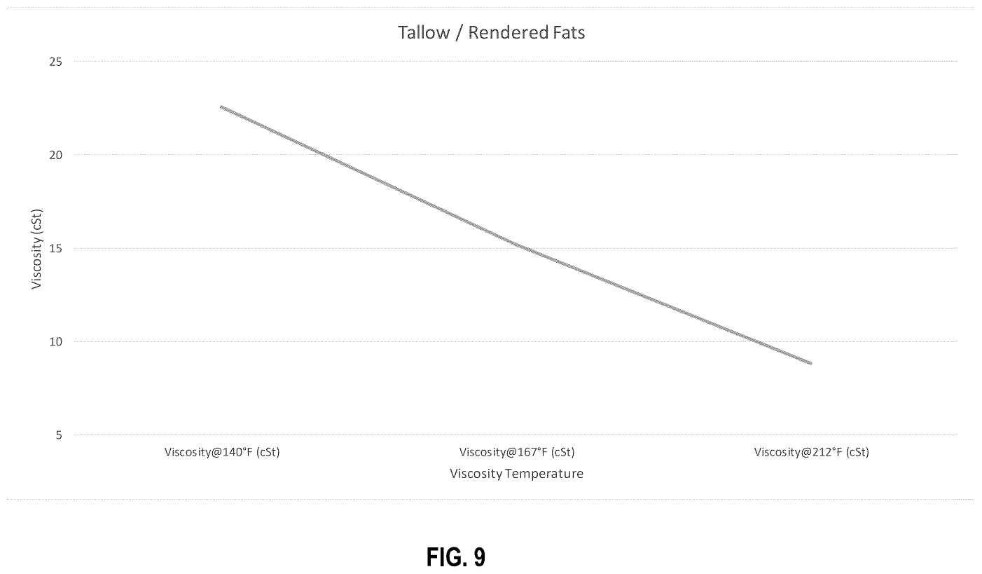

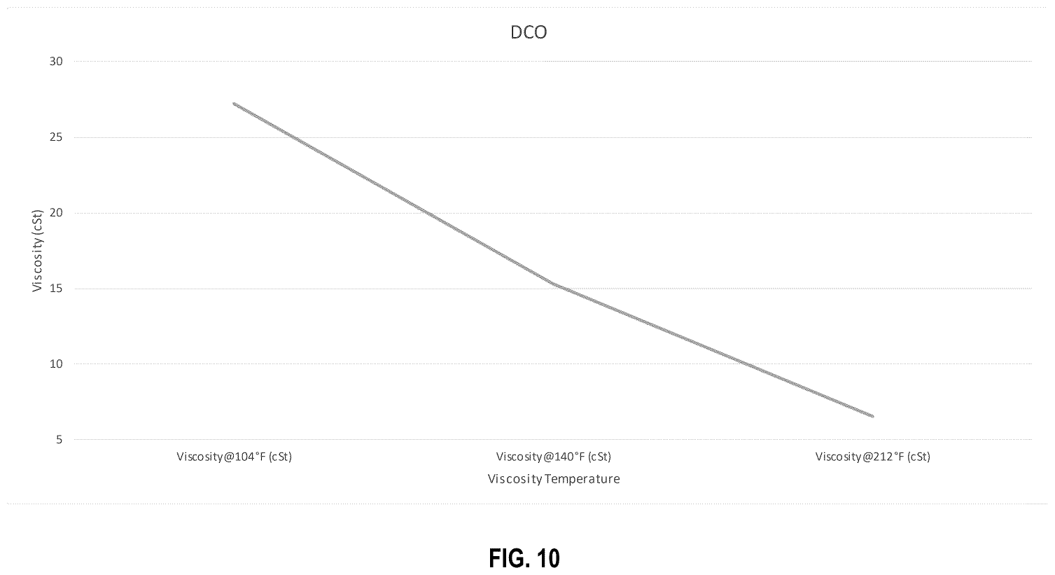

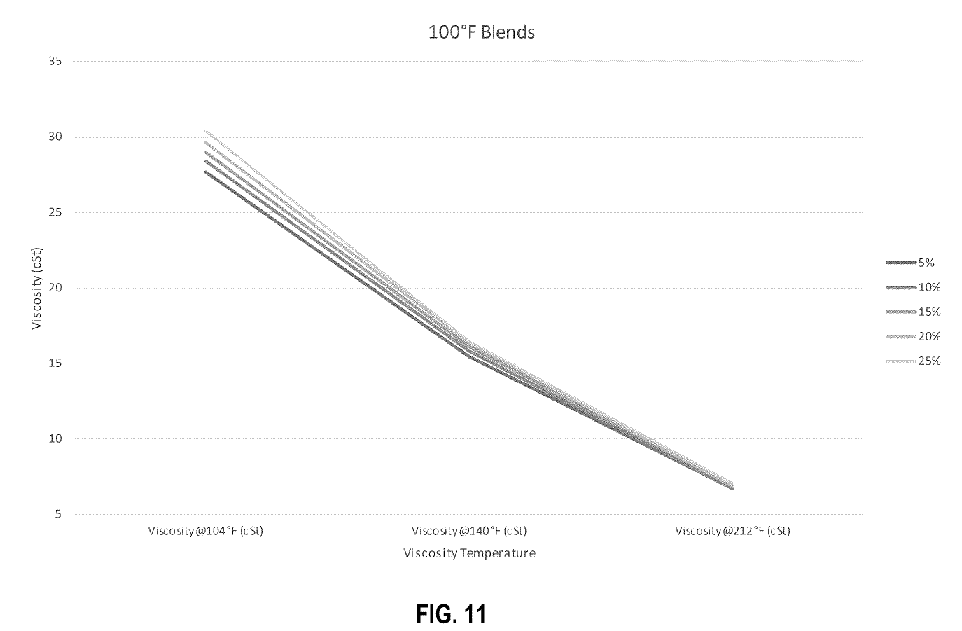

As shown in Table 2 and Table 3, increasing the amount of DCO mixed with tallow decreased the pour point temperature of the blended tallow. For example, rendered fats alone, as illustrated in FIG. 9, are more viscous at lower temperatures. A biological-based oil, such as DCO, as illustrated in FIG. 10, is less viscous than rendered fats at the same temperature. However, as in FIG. 11, the viscosity increases as rendered fats increases in the blend between rendered fats and DCO at 100° F. The viscosity also increases as rendered fats increases in the blend between rendered fats and DCO at 125° F. As seen in Table 2 and Table 3, at 25% tallow and 75% DCO at 100° F., the pour point is about 32° F. At 5% tallow and 95% DCO at 100° F., the pour point is about 21.2° F. The pour point decreased almost 11° F. The pour point of blended tallow at 125° F. remained in the same range as blended tallow at 100° F. Without wishing to be bound by theory, it is believed that the decrease in pour point is due to the lower pour point of DCO at about 19.4OF compared to tallow pour point at about 87.8° F., as seen in Table 2 and Table 3.

TABLE 2

| | | | Temp of | | | | | |
|---|---|---|---|---|---|---|---|---|
| | | | Observed | | D5950 | D5950 | D5771 | D5771 |
| | | | blend | | Pour | Pour | Cloud | Cloud |
| Blend | | | clarity | | Point | Point | Point | Point |
| Temperature* | Tallow | DCO | (F.)** | API@60° F. | (° C.) | (° F.) | (° C.) | (° F.) |
| 100° F. | 0% | 100% | | 22.2 | −7 | 19 | 1 | 34 |
| Blends | 5% | 95% | 95 | 22.2 | −6 | 21 | 10 | 50 |
| | 10% | 90% | 95 | 22.2 | −6 | 21 | 15 | 59 |
| | 15% | 85% | 100 | 22.3 | −5 | 23 | 17 | 63 |
| | 20% | 80% | 100 | 22.3 | −3 | 27 | 19 | 66 |
| | 25% | 75% | 100 | 22.4 | 0 | 32 | 20 | 68 |
| | 30% | 70% | 100 | | 8 | 46 | | |
| | 35% | 65% | 100 | | 12 | 54 | | |
| | 40% | 60% | 100 | | 17 | 63 | | |
| | 50% | 50% | 110 | | 19 | 66 | | |
| | 60% | 40% | 110 | | 22 | 72 | | |
| | 70% | 30% | 110 | | 28 | 82 | | |
| | 80% | 20% | 110 | | 28 | 82 | | |
| | 90% | 10% | 115 | | 30 | 86 | | |
| | 100% | 0% | | 21.6 | 31 | 88 | | |
| | 0% | 100% | | 22.2 | −7 | 19 | 1 | 34 |
| 125° F. | 5% | 95% | | 22.2 | −6 | 21 | 9 | 48 |
| blends | 10% | 90% | | 22.2 | −6 | 21 | 14 | 57 |
| | 15% | 85% | | 22.3 | −3 | 27 | 17 | 63 |
| | 20% | 80% | | 22.3 | 1 | 34 | 20 | 68 |
| | 25% | 75% | | 22.4 | 1 | 34 | 21 | 70 |

TABLE 3

| | | | Final | D445 | D445 | D445 | D445 |
|---|---|---|---|---|---|---|---|
| | | | Melting | Viscosity@ | Viscosity@ | Viscosity@ | Viscosity@ |
| Blend | | | Point | 104° F. | 140° F. | 167° F. | 212° F. |
| Temperature* | Tallow | DCO | (° F.) | (cSt) | (cSt) | (cSt) | (cSt) |
| | 0% | 100% | | 27.24 | 15.26 | | 6.572 |
| 100° F. | 5% | 95% | | 27.65 | 15.47 | | 6.692 |
| Blends | 10% | 90% | | 28.35 | 15.81 | | 6.70 |
| | 15% | 85% | | 28.94 | 16.07 | | 6.885 |
| | 20% | 80% | | 29.58 | 16.37 | | 6.820 |
| | 25% | 75% | | 30.43 | 16.43 | | 7.014 |
| | 30% | 70% | | | | | |
| | 35% | 65% | | | | | |
| | 40% | 60% | | | | | |
| | 50% | 50% | | | | | |
| | 60% | 40% | | | | | |
| | 70% | 30% | | | | | |
| | 80% | 20% | | | | | |
| | 90% | 10% | | | | | |
| | 100% | 0% | 110.3 | | 22.56 | 15.2 | 8.817 |
| | 0% | 100% | | 27.24 | 15.26 | | 6.572 |
| 125° F. | 5% | 95% | | 27.78 | 15.49 | | 6.674 |
| blends | 10% | 90% | | 28.41 | 15.80 | | 6.777 |
| | 15% | 85% | | 29.07 | 16.09 | | 6.871 |
| | 20% | 80% | | 29.71 | 16.40 | | 6.959 |
| | 25% | 75% | | 30.50 | 16.69 | | 7.106 |

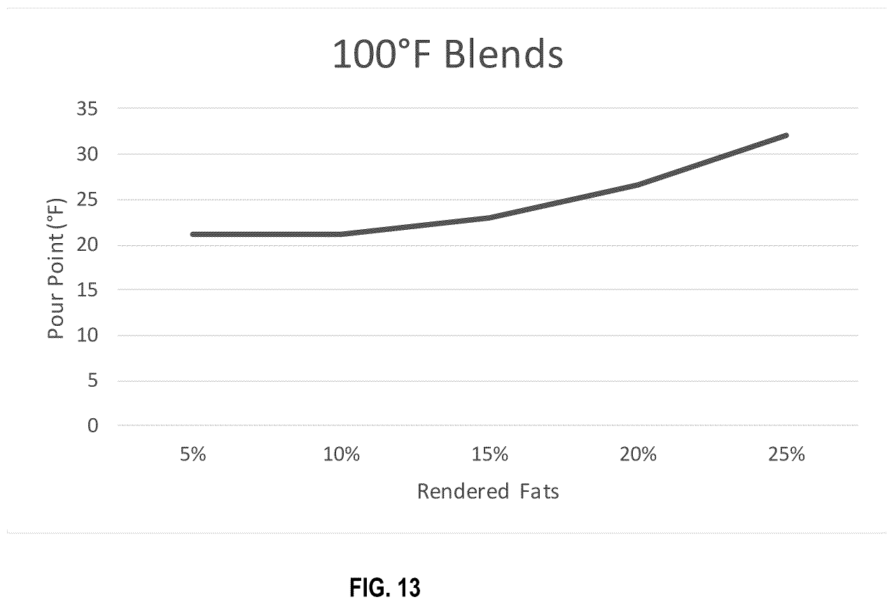

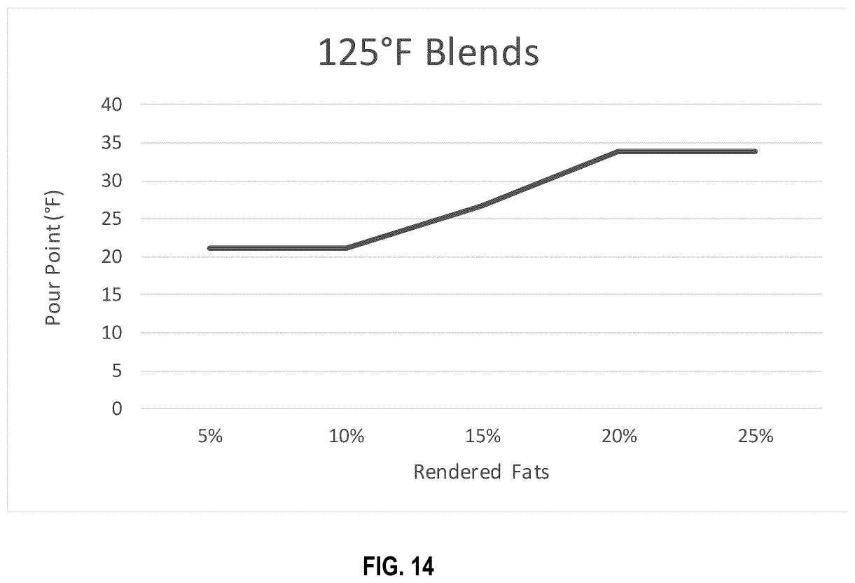

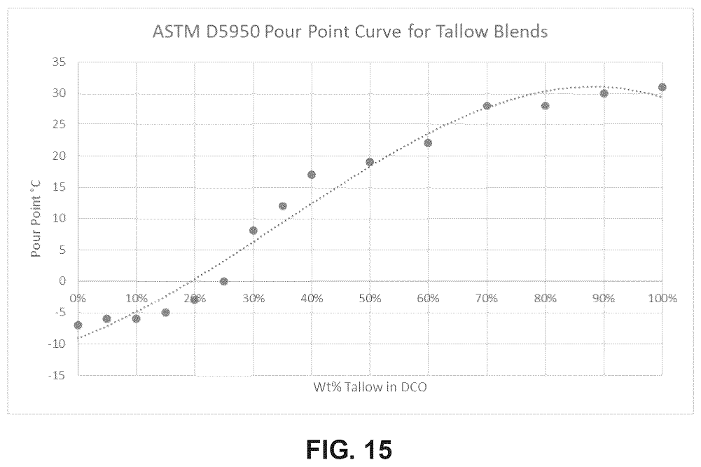

In FIGS. 13-15, the pour point of the blended tallows at varying ratios are compared. As shown in FIGS. 13-15, the pour point decreased with less rendered fats by weight percent of the blended tallow. As shown in FIGS. 13-14, no substantial difference existed between the 100° F. test samples and the 125° F. test samples.

Testing to evaluate the cloud point of blended tallows at varying ratios of the rendered fats and DCO in the blended tallows was carried out in accordance with ASTM D5771 (https://www.astm.org/d5771-21.html), as will be understood by those skilled in the art. As seen in Table 2, increasing the ratio of DCO mixed with tallow, decreased the cloud point temperature of the blended tallow. For example, at 25% tallow and 75% DCO at 100° F., the cloud point is about 68° F. At 5% tallow and 95% DCO at 100° F., the cloud point is about 50° F. The cloud point decreased 18° F. The cloud point of blended tallow at 125° F. remained in the same range as blended tallow at 100° F. Without wishing to be bound by theory, it is believed that the decrease in the cloud point at higher ratios of DCO in the blended tallow is due to the cloud point of DCO at about 33.8° F.

Testing to evaluate the viscosity of blended tallows at varying ratios of the rendered fats and DCO in the blended tallows was carried out in accordance with ASTM D445 (https://https://www.astm.org/d0445-19.html) as will be understood by those skilled in the art. As seen in Table 2, increasing the amount of DCO mixed with tallow decreased the viscosity of the blended tallow. For example, at 25% tallow and 75% DCO at 100° F., the viscosity at 104 degrees Fahrenheit (104° F.) is about 30.43 centistokes (cSt). At 5% tallow and 95% DCO at 100 degrees Fahrenheit, the viscosity at 104° F. is about 27.65 cSt. The viscosity decreased almost 3 cSt. The viscosity of blended tallow at 125° F. remained in the same range as blended tallow at 100° F. Without wishing to be bound by theory, it is believed that the decrease in viscosity at higher ratios of DCO in the blended tallow is due to the viscosity of DCO at about 27.24 cSt. At 104° F., tallow is not above its melting point, thus viscosity cannot be measured. As shown in FIGS. 13 and 14, viscosity measured at higher temperatures, however, significantly increased the flow of the blended tallow when compared to viscosity measure at low temperatures.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

The present application claims priority to and the benefit of U.S. Provisional Application No. 63/267,317, filed Jan. 31, 2022, titled “SYSTEMS AND METHODS FOR REDUCING RENDERED FATS POUR POINT AND TRANSPORTING BLENDED FAT BASED COMPOSITIONS,” the disclosure of which is incorporated herein by reference in its entirety.

In the drawings and specification, several embodiments of systems and methods for reducing a pour point of rendered fats and transporting a blended fat based composition have been disclosed, and although specific terms are employed, the terms are used in a descriptive sense only and not for purposes of limitation. Embodiments of systems and methods have been described in considerable detail with specific reference to the illustrated embodiments. However, it will be apparent that various modifications and changes may be made within the spirit and scope of the embodiments of methods and compositions as described in the foregoing specification, and such modifications and changes are to be considered equivalents and part of this disclosure.

1-30. (canceled)

31. A system for forming a blended fat composition having a lower pour point than rendered fats to facilitate transporting the blended fat composition from a first location to a second location, the system comprising:
a mixing device configured to mix rendered fats and bio-based oil to form a blended fat composition;
a first pump configured to receive the rendered fats at a first temperature greater than or equal to a pour point of the rendered fats and provide the rendered fats to the mixing device;
a second pump configured to receive the bio-based oil at a second temperature greater than or equal to a pour point of the bio-based oil and provide the bio-based oil to the mixing device;
a first flow meter disposed between the first pump and the mixing device, the first flow meter configured to measure a flow rate of the rendered fats to the mixing device;
a second flow meter disposed between the second pump and the mixing device, the second flow meter configured to measure a flow rate of the bio-based oil to the mixing device;
a sensor configured to measure a temperature of the blended fat composition; and
a controller configured to adjust the flow rate of at least one of the rendered fats or the bio-based oil responsive to maintain a preselected ratio of the rendered fats to the bio-based oil.

32. The system of claim 31, wherein the preselected ratio is selected to achieve a pour point of the blended fat composition lower than the pour point of the rendered fats for transport of the blended fat composition.

33. The system of claim 31, wherein the controller is configured to adjust the preselected ratio responsive to the pour point of the blended fat composition being greater than the pour point of the rendered fats or the temperature of the blended fat composition being less than the pour point of the rendered fats.

34. The system of claim 31, wherein the mixing device comprises a mixing tank.

35. The system of claim 31, wherein the sensor is located in the mixing device.

36. The system of claim 31, wherein the bio-based oil comprises corn oil, soybean oil, sorghum oil, canola oil, rapeseed oil, algal oil, fish oil, chufa oil, tigernut oil, sativa seed oil, or coconut oil.

37. The system of claim 31, further comprising one or more transport vehicles configured to receive the blended fat composition from the mixing device.

38. The system of claim 37, further comprising a heating element in the one or more transport vehicles.

39. The system of claim 37, further comprising a tank configured to receive the blended fat composition offput from the one or more transport vehicles.

40. The system of claim 31, further comprising a control valve in fluid communication with the mixing device and configured to control a flow rate of the blended fat composition from the mixing device.

41. The system of claim 40, further comprising a third flow meter disposed downstream of the control valve and configured to measure the flow rate of the blended fat composition flowing from the mixing device.

42. The system of claim 31, further comprising a tank configured to receive the blended fat composition a distance from the mixing device.

43. The system of claim 31, wherein the controller is configured to:
control a mixing element and a heating element of the mixing device;
control the flow rate of the rendered fats to the mixing device;
control the flow rate of the bio-based oil to the mixing device; and
control a flow rate of the blended fat composition from the mixing device.

44. The system of claim 31, further comprising a heat source disposed between a source of the rendered fats and the mixing device, the heat source configured to heat the rendered fats.

45. The system of claim 31, wherein the mixing device comprises a transport vehicle.

46. A system for forming a blended fat composition having a lower pour point than rendered fats to facilitate transporting the blended fat composition from a first location to a second location, the system comprising:
a rendered fats flow control valve configured to control a flow rate of rendered fats flowing from a source of rendered fats;
a bio-based oil flow control valve configured to control a flow rate of a bio-based oil flowing from a source of bio-based oil;
a blended fat flow control valve configured to control a flow rate of a blended fat composition exiting a mixing device, the blended fat composition obtained by mixing, in the mixing device, the rendered fats flowing from the rendered fats flow control valve and the bio-based oil flowing from the bio-based oil flow control valve;
a sensor configured to measure a temperature of the blended fat composition; and
a controller configured to:
control operation of the rendered fats flow control valve to adjust the flow rate of the rendered fats;
control operation of the bio-based oil flow control valve to adjust the flow rate of the bio-based oil; and
maintain a preselected ratio of the rendered fats to the bio-based oil.

47. The system of claim 46, further comprising a tank downstream of the blended fat flow control valve.

48. The system of claim 47, wherein:
the mixing device comprises a tank; and
the sensor is located within the tank.

49. A method of transporting a blended fat composition having a lower pout point than rendered fats, the method comprising:
pumping rendered fats with a first pump from a source of rendered fats to a mixing device, the first pump configured to receive the rendered fats at a first temperature greater than or equal to a pour point of the rendered fats;
pumping a bio-based oil with a second pump from a source of the bio-based oil to the mixing device, the second pump configured to receive the bio-based oil at a second temperature greater than or equal to a pour point of the bio-based oil;
mixing, in the mixing device, the rendered fats flowing from the first pump and the bio-based oil flowing from the second pump to form a blended fat composition;
measuring, with a first meter disposed between the first pump and the mixing device, a flow rate of the rendered fats to the mixing device;
measuring, with a second meter disposed between the second pump and the mixing device, a flow rate of the bio-based oil to the mixing device;
measuring a temperature of the blended fat composition with a sensor; and
adjusting at least one of the flow rate of the rendered or the flow rate of the bio-based oil to maintain a preselected ratio of the rendered fats to the bio-based oil.

50. The method of claim 49, wherein the preselected ratio is selected to achieve a pour point of the blended fat composition lower than the pour point of the rendered fats for transport of the blended fat composition.
